(19) United States
(12) Patent Application Publication
(10) Pub. No.: US 2024/0390848 A1
(43) Pub. Date: Nov. 28, 2024

(54) APPARATUS AND METHOD FOR MERCURY REMOVAL

(71) Applicant: W. L. Gore & Associates, Inc., Newark, DE (US)

(72) Inventors: Xiao-Chun Lu, Hockessin, DE (US); Steven J. Hardwick, Newark, DE (US); Uwe Beuscher, Landenberg, PA (US)

(21) Appl. No.: 18/693,028

(22) PCT Filed: Sep. 15, 2022
(86) PCT No.: PCT/US2022/043633

§ 371 Date: Mar. 18, 2024

Related U.S. Application Data
(60) Provisional application No. 63/245,596, filed on Sep. 17, 2021.

(51) Int. Cl. B01D 53/64; B01D 53/02; B01J 20/02; B01J 20/10; B01J 20/16; B01J 20/20; B01J 20/28; B01J 20/32

(52) U.S. Cl. CPC B01D 53/64; B01D 53/02; B01J 20/0233; B01J 20/0288; B01J 20/103; B01J 20/165; B01J 20/20; B01J 20/28026; B01J 20/3204; B01D 2253/202; B01D 2255/104; B01D 2257/602; B01D 2258/0283; B01J 2523/18

(57) ABSTRACT

Apparatus and methods which can remove, for example, mercury (Hg) from industrial flue gases. An exemplary sorbent polymer composite (SPC) can include a polymer, a sorbent which has a microstructure, and a transition metal halide in the microstructure. The transition metal halide can include silver (Ag), iodine (I), or both (AgI). A method for producing the SPC can include applying a non-halide salt of a transition metal to a sorbent, applying a non-transition metal halide to the sorbent, so as to react the non-transition metal halide with the non-halide salt of the transition metal, thereby forming a transition metal halide within the microstructure of the sorbent.

### CROSS-REFERENCE TO RELATED APPLICATION

This application is a national phase application of PCT Application No. PCT/US2022/043633, internationally filed on Sep. 15, 2022, which claims the benefit of Provisional Application No. 63/245,596, filed Sep. 17, 2021, which are incorporated herein by reference in their entireties for all purposes.

### FIELD

This disclosure relates generally to pollution control devices and methods for removing compounds and fine particulate matters from gas streams.

### BACKGROUND

Coal-fired power generation plants, municipal waste incinerators, and oil refinery plants generate large amounts of flue gases that contain substantial varieties and quantities of environmental pollutants, such as sulfur oxides (SO₂, and SO₃), nitrogen oxides (NO, NO₂), mercury (Hg) vapor, and particulate matters (PM). There is a need for improvements to methods for removing mercury vapor and fine particulate matters from industrial flue gases.

### SUMMARY

Any or all portion(s) of any of the embodiments disclosed herein may be combined with any other portion(s) of any embodiment.

In some embodiments, a sorbent polymer composite (SPC) comprises a polymer; and a sorbent; and a transition metal halide, wherein the transition metal halide is present within a microstructure of the sorbent. In some embodiments, the SPC comprises sulfur. In some embodiments, the sulfur includes elemental sulfur. In some embodiments, the sulfur is elemental sulfur. In some embodiments, the sulfur is present in an amount ranging from 0.1 wt % to 20 wt % based on a total weight of the SPC.

In some embodiments, the transition metal halide comprises a transition metal chloride. In some embodiments, the transition metal halide comprises a transition metal bromide. In some embodiments, the transition metal halide comprises a transition metal fluoride. In some embodiments, the transition metal halide comprises a transition metal iodide.

In some embodiments, the transition metal halide comprises nickel. In some embodiments, the transition metal halide comprises lead. In some embodiments, the transition metal halide comprises copper. In some embodiments, the transition metal halide comprises manganese. In some embodiments, the transition metal halide comprises iron. In some embodiments, the transition metal halide comprises mercury. In some embodiments, the transition metal halide comprises platinum.

In some embodiments, the transition metal halide comprises silver (Ag). In some embodiments, the transition metal halide comprises iodine or its ionic form, iodide (I). In some embodiments, the transition metal halide comprises silver iodide (AgI).

In some embodiments, the SPC is configured for at least 6 months of operational use (i.e., being exposed to flue gas with at least SO₂) for reacting with mercury (Hg), wherein the concentration of silver (Ag) is substantially unchanged throughout the at least 6 months of operational use. In some embodiments, the SPC is configured for at least 6 months of operational use for reacting with mercury (Hg), wherein the concentration of silver (Ag) is not reduced throughout the at least 6 months of operational use. In some embodiments, the SPC is configured for at least 6 months of operational use for reacting with mercury (Hg), wherein the concentration of silver (Ag) is substantially not reduced throughout the at least 6 months of operational use.

In some embodiments, the SPC is configured for at least 6 months of operational use for reacting with mercury (Hg), wherein the concentration of iodine or iodide (I) is substantially unchanged throughout the at least 6 months of operational use. In some embodiments, the SPC is configured for at least 6 months of operational use for reacting with mercury (Hg), wherein the concentration of iodine or iodide (I) is not reduced throughout the at least 6 months of operational use. In some embodiments, the SPC is configured for at least 6 months of operational use for reacting with mercury (Hg), wherein the concentration of iodine or iodide (I) is substantially not reduced throughout the at least 6 months of operational use.

In some embodiments, the SPC is configured for at least 6 months of operational use for reacting with mercury (Hg), wherein the concentration of silver (Ag) and the concentration of iodine or iodide (I) are substantially unchanged throughout the at least 6 months of operational use. In some embodiments, the SPC is configured for at least 6 months of operational use for reacting with mercury (Hg), wherein the concentration of silver (Ag) and the concentration of iodine or iodide (I) are not reduced throughout the at least 6 months of operational use. In some embodiments, the SPC is configured for at least 6 months of operational use for reacting with mercury (Hg), wherein the concentration of silver (Ag) and the concentration of iodine or iodide (I) are substantially not reduced throughout the at least 6 months of operational use.

The term “substantially unchanged” as used herein describes an approximate value change from a starting value that is within a ±10% range of the starting value.

The term “substantially not reduced” as used herein describes an approximate value change from a starting value that is at most a −10% change.

In some embodiments, the sorbent has an adsorption capacity Langmuir Isotherm parameter qₘ, for a non-halide salt of a transition metal silver nitrate (AgNO₃) of 1,765 mmole/L or more at 23° C.

In some embodiments, the polymer comprises a fluoropolymer. In some embodiments, the polymer comprises polytetrafluoroethylene (PTFE).

In some embodiments, the transition metal halide is present in the SPC an amount of 0.1 wt %. to 20 wt % based on a total weight of the SPC.

In some embodiments, the sorbent comprises activated carbon, a silica gel, a zeolite, or any combination thereof. In some embodiments, the sorbent comprises activated carbon. In some embodiments, the activated carbon is derived from a carbon source, wherein the carbon source includes coal, lignite, wood, coconut shells, or any combination thereof.

In some embodiments, the SPC further comprises elemental sulfur, wherein the sorbent comprises activated carbon, and wherein the transition metal halide is silver iodide (AgI).

In some embodiments, the application is characterized by the following formula:

transition metal non-halide salt+non-transition metal halide→transition metal halide+non-transition metal non-halide salt

In some embodiments, the application is characterized by the following formula:

$${AgNO}_{3} + KI \to AgI + {KNO}_{3}$$

In some embodiments of methods, a method comprises obtaining a sorbent polymer composite (SPC), wherein the SPC comprises a polymer and a sorbent; obtaining a non-halide salt of a transition metal; obtaining a non-transition metal halide; applying the non-halide salt of the transition metal to the sorbent, so as to incorporate the non-halide salt of the transition metal within a microstructure of the sorbent; and applying the non-transition metal halide to the sorbent, so as to react the non-transition metal halide with the non-halide salt of the transition metal, thereby forming a transition metal halide within the microstructure of the sorbent.

In some embodiments of the method, a non-transition metal salt is also formed within the microstructure of the sorbent, wherein the method further comprises removing the non-transition metal salt from the sorbent. In some embodiments of the method, removing the non-transition metal salt from the sorbent comprises dissolving the non-transition metal salt from the sorbent using a solvent.

In some embodiments of the method, the solvent includes water. In some embodiments of the method, the solvent includes alcohol. In some embodiments of the method, the solvent includes at least one of, water, alcohol, or a combination thereof. In some embodiments, the alcohol includes methanol, ethanol, or a combination thereof. In some embodiments of the method, the solvent includes at least one of, water, methanol, ethanol, or a combination thereof.

In some embodiments, the non-transition metal halide comprises an alkali metal halide. In some embodiments, the non-transition metal halide comprises an alkali earth metal halide. In some embodiments, the non-transition metal halide comprises an ammonium halide. In some embodiments, the non-transition metal halide comprises, at least, lithium, sodium, potassium, rubidium, cesium, or francium.

In some embodiments, the non-halide salt of the transition metal comprises a transition metal sulfate. In some embodiments, the non-halide salt of the transition metal comprises a transition metal sulfite. In some embodiments, the non-halide salt of the transition metal comprises a transition metal nitrite. In some embodiments, the non-halide salt of the transition metal comprises a transition metal nitrate. In some embodiments, the non-halide salt of the transition metal comprises a transition metal acetate. In some embodiments, the non-halide salt of the transition metal comprises a transition metal chlorate. In some embodiments, the non-halide salt of the transition metal comprises a transition metal perchlorate.

In some embodiments of the method, the sorbent comprises activated carbon; wherein the non-halide salt of the transition metal comprises silver nitrate (AgNO₃); wherein the non-transition metal halide is potassium iodide (KI); and wherein the transition metal halide is silver iodide (AgI); and wherein reaction of the non-halide salt of the transition metal with the non-transition metal halide comprises the following. The resulting non-transition metal salt being potassium nitrate (KNO₃):

$${AgNO}_{3} + KI \to AgI + {KNO}_{3} .$$

In some embodiments, the method further comprises obtaining the polymer; and forming the sorbent polymer composite (SPC) from the sorbent and the polymer. In some embodiments of the method, the polymer comprises polytetrafluoroethylene (PTFE).

In some embodiments, the method further comprises obtaining sulfur; and incorporating the sulfur into the SPC. In some embodiments of the method, the SPC comprises elemental sulfur (S). In some embodiments of the method, the transition metal is silver (Ag).

In some embodiments of the method, the non-halide salt of the transition metal is applied to the sorbent as a solution. In some embodiments of the method, the solution is applied by spraying the solution onto the sorbent, immersing the sorbent in the solution, or any combination thereof.

In some embodiments of the method, the solution comprises 1 mmol/L to 100 mmol/L of the non-halide salt of the transition metal in water.

In some embodiments, a method comprises obtaining a sorbent polymer composite (SPC), wherein the SPC comprises a transition metal halide, and sulfur; and flowing a gas comprising mercury to contact the SPC, whereby mercury sulfide (HgS) is formed by a catalytic reaction of the mercury and the sulfur wherein the transition metal acts as a catalyst. In some embodiments of the method, the transition metal halide comprises silver (Ag). In some embodiments of the method, flowing the gas is operated for at least 6 months, wherein a concentration of silver (Ag) of the SPC is substantially unchanged throughout the at least 6 months. In some embodiments of the method, the transition metal halide comprises iodine or iodide (I). In some embodiments of the method, flowing the gas is operated for at least 6 months, wherein a concentration of iodine or iodide (I) of the SPC is substantially unchanged throughout the at least 6 months. In some embodiments of the method, the transition metal halide comprises silver iodide (AgI). In some embodiments of the method, flowing the gas is operated for at least 6 months, wherein a concentration of silver iodide (AgI) of the SPC is substantially unchanged throughout the at least 6 months.

### BRIEF DESCRIPTION OF THE DRAWINGS

References are made to the accompanying drawings that form a part of this disclosure and that illustrate embodiments in which the systems and methods described in this Specification can be practiced.

FIG. 1 shows a schematic illustration of a flue gas treatment unit, according to some embodiments of the present disclosure;

FIGS. 2A and 2B are simplified illustrations of sorbent polymer composites in accordance with some embodiments of the present disclosure;

FIG. 3 is a flowchart according to some embodiments of the methods;

FIG. 4 is a flowchart according to some embodiments of the methods;

FIG. 5 is a flowchart according to some embodiments of the methods;

FIG. 6 shows the Langmuir Isotherm determination graphs for Examples 1 and 2;

FIG. 7 shows the data of mercury removal efficiency test for Examples 3, 4, and 5;

FIG. 8 shows the data of mercury removal efficiency test for Examples 5, 6, and 7;

FIG. 9 shows the data from a lab durability test for Example 6;

FIG. 10 shows the data from a lab durability test for Example 8;

FIG. 11 shows data from a I field durability test for Example 8;

FIG. 12 shows XANES graphs for Examples A, B, and HgO powder;

FIG. 13 shows a derivatives of the XANES spectra of FIG. 12;

FIG. 14 shows XANES graphs for Examples C, D, E, and HgS powder; and

FIG. 15 shows a derivatives of the XANES spectra of FIG. 14.

Like reference numbers represent the same or similar parts throughout.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive. All embodiments of the disclosure are intended to be combinable without departing from the scope or spirit of the disclosure.

As used herein, a “flue gas” refers to a gaseous mixture that comprises at least one byproduct of a combustion process (such as, but not limited to, a coal combustion process). In some embodiments, a flue gas may consist entirely of byproducts of a combustion process. In some embodiments, a flue gas may include at least one gas in an elevated concentration relative to a concentration resulting from the combustion process. In some embodiments, a flue gas may include at least one gas in a lesser concentration relative to an initial concentration of the at least one gas output from the combustion process. This may occur, for example, by removing at least a portion at least one gas after combustion. In some embodiments, a flue gas may take the form of a gaseous mixture that is a combination of byproducts of multiple combustion processes.

As used herein, the term “sorbent” means a substance which has the property of collecting molecules of another substance by at least one of absorption, adsorption, or combinations thereof.

As used herein, the term “composite” refers to a material including two or more constituent materials with different physical or chemical properties that, when combined, result in a material with characteristics different from the individual components.

As used herein, a “sorbent polymer composite” (SPC) is a composite that includes a sorbent and a polymer. In embodiments the sorbent polymer composite may comprise sorbent particles that are incorporated into a microstructure of a polymer.

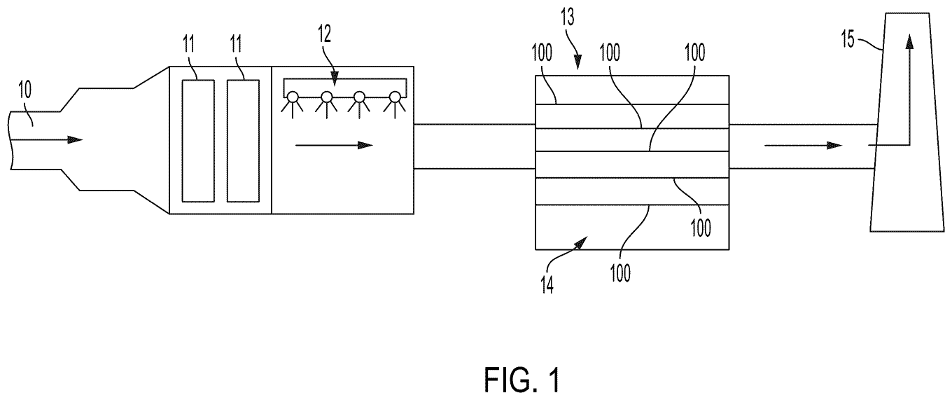

Some embodiments of the present disclosure relate to a device. FIG. 1 shows a schematic of an exemplary device according to some non-limiting embodiments of the present disclosure. As shown, flue gas 10 stream from a combustor may be reduced in temperature by heat exchangers and introduced in an electrostatic precipitator or bag house 11. In some embodiments, the treated flue gas stream can be further reduced in temperature by a treatment unit 12. In some embodiments, the treatment unit 12 includes a water spray which will additionally increase gas humidity. In some embodiments, the treated flue gas is introduced into a sorbent housing 13 that includes a sorbent polymer composite 100 according to some embodiments of the present disclosure. In some embodiments, the sorbent house may conveniently be located at the top of a limestone scrubber. In some embodiments, metal vapor in the treated flue gas 10 is absorbed onto the sorbent polymer composite 100. In some embodiments, expelled sulfuric acid may drip down to an acid reservoir 14. In some embodiments, treated flue gas exits the sorbent housing 13 and exits a stack 15. Accordingly, in some embodiments, “operational use” as used herein means use in the treatment unit 12 as a part of the sorbent housing 13, being exposed to the flue gas which includes, at least, SO₂.

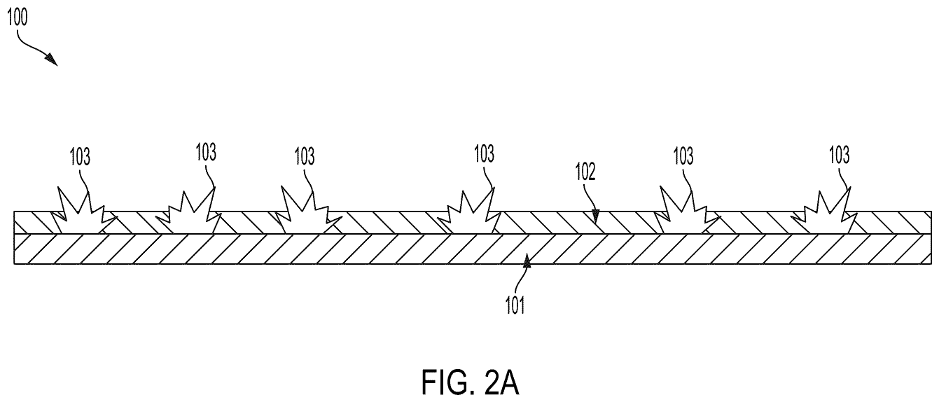

FIG. 2A depicts a non-limiting embodiment of a sorbent polymer composite 100 described herein, in a cross-sectional view. In this non-limiting embodiment, the sorbent polymer composite 100 includes a sorbent 102 that partially or completely covers a polymer 101. In some non-limiting embodiments, a transition metal halide 103 (as described herein) can partially or completely cover portions of the sorbent 102. In some embodiments, the sorbent 102 includes carbon. In some embodiments, the sorbent 102 particles may be activated carbon particles. In some embodiments, the transition metal halide 103 may be imbibed into pores of the sorbent 102. In some embodiments, the transition metal halide 103 may be adsorbed to the sorbent 102. In some embodiments, the sorbent 102 has a microstructure which includes or has the transition metal halide 103 in the microstructure. The transition metal halide 103 can be, at least, nickel chloride, lead chloride, cuprous chloride, manganese chloride, ferrous chloride, mercuric chloride, silver chloride, platinum chloride, nickel bromide, lead bromide, cuprous bromide, manganese bromide, ferrous bromide, mercuric bromide, silver bromide, platinum bromide, nickel fluoride, lead fluoride, cuprous fluoride, manganese fluoride, ferrous fluoride, mercuric fluoride, silver fluoride, platinum fluoride, nickel iodide, lead iodide, cuprous iodide, manganese iodide, ferrous iodide, mercuric iodide, silver iodide, platinum iodide, or any combination thereof.

FIG. 2B depicts an additional a non-limiting embodiment of a sorbent polymer composite 100 described herein. As shown, sorbent polymer composite 100 may comprise sorbent 202 particles that are incorporated into a microstructure 201 of a polymer. In some embodiments, the microstructure 201 of the polymer may comprise fibrils. In some embodiments, the polymer may be expanded PTFE.

Additional non-limiting configurations of the sorbent polymer composite described herein are set out in U.S. Pat. No. 9,827,551 to Hardwick et al and U.S. Pat. No. 7,442,352 to Lu et al, each of which are incorporated by reference herein in their entireties. In some embodiments, the sorbent polymer composite can be prepared using a general dry blending methodology taught in U.S. Pat. No. 7,791,861, which is incorporated by reference herein in its entirety.

In some embodiments, the sorbent of the sorbent polymer composite comprises activated carbon, silica gel, zeolite, or combinations thereof. In some embodiments, the activated carbon is coal-derived carbon, lignite-derived carbon, wood-derived carbon, coconut-derived carbon or any combination thereof. In some embodiments, when the sorbent is combined with the polymer, the resulting mixture can be stretched to form a porous structure without displacing the sorbent. The sorbent of the sorbent polymer composite has a surface area in excess of 400 m²/g. In some embodiments, the sorbent of the sorbent polymer composite has a surface area in excess of 600 m²/g. In some embodiments, the sorbent of the sorbent polymer composite has a surface area in excess of 800 m²/g. In some embodiments, the sorbent of the sorbent polymer composite has a surface area in excess of 1000 m²/g. In some embodiments, the sorbent of the sorbent polymer composite has a surface area in excess of 1200 m²/g. In some embodiments, the sorbent of the sorbent polymer composite has a surface area in excess of 1400 m²/g. In some embodiments, the sorbent of the sorbent polymer composite has a surface area in excess of 1600 m²/g. In some embodiments, the sorbent of the sorbent polymer composite has a surface area in excess of 1800 m²/g. In some embodiments, the sorbent of the sorbent polymer composite has a surface area in excess of 2000 m²/g.

In some embodiments, the sorbent may have an adsorption capacity Langmuir Isotherm parameter qₘ of from 1 mmole/L to 10 mmole/L at 23° C., or from 2 mmole/L to 10 mmole/L, or from 3 mmole/L to 10 mmole/L, or from 4 mmole/L to 10 mmole/L, or from 5 mmole/L to 10 mmole/L, or from 7 mmole/L to 10 mmole/L, or the sorbent may have an adsorption capacity Langmuir Isotherm parameter qₘ of any value encompassed by these ranges.

The polymer of the sorbent polymer composite includes at least one of: polyfluoroethylene propylene (PFEP); polyperfluoroacrylate (PPFA); polyvinylidenefluoride (PVDF); a terpolyrner of tetrafluoroethylene, hexafluoropropylene-vinylidene-fluoride (THV), or polychlorotrifluoroethylene (PCFE), or combinations thereof. In some embodiments, the polymer is polytetrafluoroethylene (PTFE). In some embodiments, the polymer is expanded polytetrafluoroethylene (ePTFE). In some embodiments, the structure of the polymer can become porous upon stretching, such that voids can form between fibrils and nodes of the polymer. The polymer of the sorbent polymer composite has a surface energy of less than 31 dynes per cm. In some embodiments, the polymer of the sorbent polymer composite has a surface energy of less than 30 dynes per cm. In some embodiments, the polymer of the sorbent polymer composite has a surface energy of less than 25 dynes per cm. In some embodiments, the polymer of the sorbent polymer composite has a surface energy of less than 20 dynes per cm. In some embodiments, the polymer of the sorbent polymer composite has a surface energy of less than 15 dynes per cm.

In some embodiments, a SPC comprises a polymer; a sorbent; and a transition metal halide, wherein the transition metal halide is present within a microstructure of the sorbent.

In some embodiments, a transition metal halide includes at least one of the following transition metal elements:
nickel, lead, copper, manganese, iron, mercury, silver, or platinum;
   and at least one of the following halides:
chloride, bromide, fluoride, or iodide.

In some embodiments, the transition metal halide is present in an amount ranging from 0.1 wt % to 1 wt % based on a total weight of the SPC. In some embodiments, the transition metal halide is present in an amount ranging from 0.1 wt % to 2 wt % based on a total weight of the SPC. In some embodiments, the transition metal halide is present in an amount ranging from 0.1 wt % to 3 wt % based on a total weight of the SPC. In some embodiments, the transition metal halide is present in an amount ranging from 0.1 wt % to 4 wt % based on a total weight of the SPC. In some embodiments, the transition metal halide is present in an amount ranging from 0.1 wt % to 5 wt % based on a total weight of the SPC. In some embodiments, the transition metal halide is present in an amount ranging from 0.1 wt % to 6 wt % based on a total weight of the SPC. In some embodiments, the transition metal halide is present in an amount ranging from 0.1 wt % to 7 wt % based on a total weight of the SPC. In some embodiments, the transition metal halide is present in an amount ranging from 0.1 wt % to 8 wt % based on a total weight of the SPC. In some embodiments, the transition metal halide is present in an amount ranging from 0.1 wt % to 9 wt % based on a total weight of the SPC. In some embodiments, the transition metal halide is present in an amount ranging from 0.1 wt % to 10 wt % based on a total weight of the SPC. In some embodiments, the transition metal halide is present in an amount ranging from 0.1 wt % to 11 wt % based on a total weight of the SPC. In some embodiments, the transition metal halide is present in an amount ranging from 0.1 wt % to 12 wt % based on a total weight of the SPC. In some embodiments, the transition metal halide is present in an amount ranging from 0.1 wt % to 13 wt % based on a total weight of the SPC. In some embodiments, the transition metal halide is present in an amount ranging from 0.1 wt % to 14 wt % based on a total weight of the SPC. In some embodiments, the transition metal halide is present in an amount ranging from 0.1 wt % to 15 wt % based on a total weight of the SPC. In some embodiments, the transition metal halide is present in an amount ranging from 0.1 wt % to 16 wt % based on a total weight of the SPC. In some embodiments, the transition metal halide is present in an amount ranging from 0.1 wt % to 17 wt % based on a total weight of the SPC. In some embodiments, the transition metal halide is present in an amount ranging from 0.1 wt % to 18 wt % based on a total weight of the SPC. In some embodiments, the transition metal halide is present in an amount ranging from 0.1 wt % to 19 wt % based on a total weight of the SPC. In some embodiments, the transition metal halide is present in an amount ranging from 0.1 wt % to 20 wt % based on a total weight of the SPC. In some embodiments, the transition metal halide is present in an amount ranging from 1 wt % to 2 wt % based on a total weight of the SPC. In some embodiments, the transition metal halide is present in an amount ranging from 1 wt % to 3 wt % based on a total weight of the SPC. In some embodiments, the transition metal halide is present in an amount ranging from 1 wt % to 4 wt % based on a total weight of the SPC. In some embodiments, the transition metal halide is present in an amount ranging from 1 wt % to 5 wt % based on a total weight of the SPC. In some embodiments, the transition metal halide is present in an amount ranging from 1 wt % to 6 wt % based on a total weight of the SPC. In some embodiments, the transition metal halide is present in an amount ranging from 1 wt % to 7 wt % based on a total weight of the SPC. In some embodiments, the transition metal halide is present in an amount ranging from 1 wt % to 8 wt % based on a total weight of the SPC. In some embodiments, the transition metal halide is present in an amount ranging from 1 wt % to 9 wt % based on a total weight of the SPC. In some embodiments, the transition metal halide is present in an amount ranging from 1 wt % to 10 wt % based on a total weight of the SPC. In some embodiments, the transition metal halide is present in an amount ranging from 1 wt % to 11 wt % based on a total weight of the SPC. In some embodiments, the transition metal halide is present in an amount ranging from 1 wt % to 12 wt % based on a total weight of the SPC. In some embodiments, the transition metal halide is present in an amount ranging from 1 wt % to 13 wt % based on a total weight of the SPC. In some embodiments, the transition metal halide is present in an amount ranging from 1 wt % to 14 wt % based on a total weight of the SPC. In some embodiments, the transition metal halide is present in an amount ranging from 1 wt % to 15 wt % based on a total weight of the SPC. In some embodiments, the transition metal halide is present in an amount ranging from 1 wt % to 16 wt % based on a total weight of the SPC. In some embodiments, the transition metal halide is present in an amount ranging from 1 wt % to 17 wt % based on a total weight of the SPC. In some embodiments, the transition metal halide is present in an amount ranging from 1 wt % to 18 wt % based on a total weight of the SPC. In some embodiments, the transition metal halide is present in an amount ranging from 1 wt % to 19 wt % based on a total weight of the SPC. In some embodiments, the transition metal halide is present in an amount ranging from 1 wt % to 20 wt % based on a total weight of the SPC. In some embodiments, the transition metal halide is present in an amount ranging from 2 wt % to 3 wt % based on a total weight of the SPC. In some embodiments, the transition metal halide is present in an amount ranging from 2 wt % to 4 wt % based on a total weight of the SPC. In some embodiments, the transition metal halide is present in an amount ranging from 2 wt % to 5 wt % based on a total weight of the SPC. In some embodiments, the transition metal halide is present in an amount ranging from 2 wt % to 6 wt % based on a total weight of the SPC. In some embodiments, the transition metal halide is present in an amount ranging from 2 wt % to 7 wt % based on a total weight of the SPC. In some embodiments, the transition metal halide is present in an amount ranging from 2 wt % to 8 wt % based on a total weight of the SPC. In some embodiments, the transition metal halide is present in an amount ranging from 2 wt % to 9 wt % based on a total weight of the SPC. In some embodiments, the transition metal halide is present in an amount ranging from 2 wt % to 10 wt % based on a total weight of the SPC. In some embodiments, the transition metal halide is present in an amount ranging from 2 wt % to 11 wt % based on a total weight of the SPC. In some embodiments, the transition metal halide is present in an amount ranging from 2 wt % to 12 wt % based on a total weight of the SPC. In some embodiments, the transition metal halide is present in an amount ranging from 2 wt % to 13 wt % based on a total weight of the SPC. In some embodiments, the transition metal halide is present in an amount ranging from 2 wt % to 14 wt % based on a total weight of the SPC. In some embodiments, the transition metal halide is present in an amount ranging from 2 wt % to 15 wt % based on a total weight of the SPC. In some embodiments, the transition metal halide is present in an amount ranging from 2 wt % to 16 wt % based on a total weight of the SPC. In some embodiments, the transition metal halide is present in an amount ranging from 2 wt % to 17 wt % based on a total weight of the SPC. In some embodiments, the transition metal halide is present in an amount ranging from 2 wt % to 18 wt % based on a total weight of the SPC. In some embodiments, the transition metal halide is present in an amount ranging from 2 wt % to 19 wt % based on a total weight of the SPC. In some embodiments, the transition metal halide is present in an amount ranging from 2 wt % to 20 wt % based on a total weight of the SPC. In some embodiments, the transition metal halide is present in an amount ranging from 3 wt % to 4 wt % based on a total weight of the SPC. In some embodiments, the transition metal halide is present in an amount ranging from 3 wt % to 5 wt % based on a total weight of the SPC. In some embodiments, the transition metal halide is present in an amount ranging from 3 wt % to 6 wt % based on a total weight of the SPC. In some embodiments, the transition metal halide is present in an amount ranging from 3 wt % to 7 wt % based on a total weight of the SPC. In some embodiments, the transition metal halide is present in an amount ranging from 3 wt % to 8 wt % based on a total weight of the SPC. In some embodiments, the transition metal halide is present in an amount ranging from 3 wt % to 9 wt % based on a total weight of the SPC. In some embodiments, the transition metal halide is present in an amount ranging from 3 wt % to 10 wt % based on a total weight of the SPC. In some embodiments, the transition metal halide is present in an amount ranging from 3 wt % to 11 wt % based on a total weight of the SPC. In some embodiments, the transition metal halide is present in an amount ranging from 3 wt % to 12 wt % based on a total weight of the SPC. In some embodiments, the transition metal halide is present in an amount ranging from 3 wt % to 13 wt % based on a total weight of the SPC. In some embodiments, the transition metal halide is present in an amount ranging from 3 wt % to 14 wt % based on a total weight of the SPC. In some embodiments, the transition metal halide is present in an amount ranging from 3 wt % to 15 wt % based on a total weight of the SPC. In some embodiments, the transition metal halide is present in an amount ranging from 3 wt % to 16 wt % based on a total weight of the SPC. In some embodiments, the transition metal halide is present in an amount ranging from 3 wt % to 17 wt % based on a total weight of the SPC. In some embodiments, the transition metal halide is present in an amount ranging from 3 wt % to 18 wt % based on a total weight of the SPC. In some embodiments, the transition metal halide is present in an amount ranging from 3 wt % to 19 wt % based on a total weight of the SPC. In some embodiments, the transition metal halide is present in an amount ranging from 3 wt % to 20 wt % based on a total weight of the SPC. In some embodiments, the transition metal halide is present in an amount ranging from 4 wt % to 5 wt % based on a total weight of the SPC. In some embodiments, the transition metal halide is present in an amount ranging from 4 wt % to 6 wt % based on a total weight of the SPC. In some embodiments, the transition metal halide is present in an amount ranging from 4 wt % to 7 wt % based on a total weight of the SPC. In some embodiments, the transition metal halide is present in an amount ranging from 4 wt % to 8 wt % based on a total weight of the SPC. In some embodiments, the transition metal halide is present in an amount ranging from 4 wt % to 9 wt % based on a total weight of the SPC. In some embodiments, the transition metal halide is present in an amount ranging from 4 wt % to 10 wt % based on a total weight of the SPC. In some embodiments, the transition metal halide is present in an amount ranging from 4 wt % to 11 wt % based on a total weight of the SPC. In some embodiments, the transition metal halide is present in an amount ranging from 4 wt % to 12 wt % based on a total weight of the SPC. In some embodiments, the transition metal halide is present in an amount ranging from 4 wt % to 13 wt % based on a total weight of the SPC. In some embodiments, the transition metal halide is present in an amount ranging from 4 wt % to 14 wt % based on a total weight of the SPC. In some embodiments, the transition metal halide is present in an amount ranging from 4 wt % to 15 wt % based on a total weight of the SPC. In some embodiments, the transition metal halide is present in an amount ranging from 4 wt % to 16 wt % based on a total weight of the SPC. In some embodiments, the transition metal halide is present in an amount ranging from 4 wt % to 17 wt % based on a total weight of the SPC. In some embodiments, the transition metal halide is present in an amount ranging from 4 wt % to 18 wt % based on a total weight of the SPC. In some embodiments, the transition metal halide is present in an amount ranging from 4 wt % to 19 wt % based on a total weight of the SPC. In some embodiments, the transition metal halide is present in an amount ranging from 4 wt % to 20 wt % based on a total weight of the SPC. In some embodiments, the transition metal halide is present in an amount ranging from 5 wt % to 6 wt % based on a total weight of the SPC. In some embodiments, the transition metal halide is present in an amount ranging from 5 wt % to 7 wt % based on a total weight of the SPC. In some embodiments, the transition metal halide is present in an amount ranging from 5 wt % to 8 wt % based on a total weight of the SPC. In some embodiments, the transition metal halide is present in an amount ranging from 5 wt % to 9 wt % based on a total weight of the SPC. In some embodiments, the transition metal halide is present in an amount ranging from 5 wt % to 10 wt % based on a total weight of the SPC. In some embodiments, the transition metal halide is present in an amount ranging from 5 wt % to 11 wt % based on a total weight of the SPC. In some embodiments, the transition metal halide is present in an amount ranging from 5 wt % to 12 wt % based on a total weight of the SPC. In some embodiments, the transition metal halide is present in an amount ranging from 5 wt % to 13 wt % based on a total weight of the SPC. In some embodiments, the transition metal halide is present in an amount ranging from 5 wt % to 14 wt % based on a total weight of the SPC. In some embodiments, the transition metal halide is present in an amount ranging from 5 wt % to 15 wt % based on a total weight of the SPC. In some embodiments, the transition metal halide is present in an amount ranging from 5 wt % to 16 wt % based on a total weight of the SPC. In some embodiments, the transition metal halide is present in an amount ranging from 5 wt % to 17 wt % based on a total weight of the SPC. In some embodiments, the transition metal halide is present in an amount ranging from 5 wt % to 18 wt % based on a total weight of the SPC. In some embodiments, the transition metal halide is present in an amount ranging from 5 wt % to 19 wt % based on a total weight of the SPC. In some embodiments, the transition metal halide is present in an amount ranging from 5 wt % to 20 wt % based on a total weight of the SPC. In some embodiments, the transition metal halide is present in an amount ranging from 6 wt % to 7 wt % based on a total weight of the SPC. In some embodiments, the transition metal halide is present in an amount ranging from 6 wt % to 8 wt % based on a total weight of the SPC. In some embodiments, the transition metal halide is present in an amount ranging from 6 wt % to 9 wt % based on a total weight of the SPC. In some embodiments, the transition metal halide is present in an amount ranging from 6 wt % to 10 wt % based on a total weight of the SPC. In some embodiments, the transition metal halide is present in an amount ranging from 6 wt % to 11 wt % based on a total weight of the SPC. In some embodiments, the transition metal halide is present in an amount ranging from 6 wt % to 12 wt % based on a total weight of the SPC. In some embodiments, the transition metal halide is present in an amount ranging from 6 wt % to 13 wt % based on a total weight of the SPC. In some embodiments, the transition metal halide is present in an amount ranging from 6 wt % to 14 wt % based on a total weight of the SPC. In some embodiments, the transition metal halide is present in an amount ranging from 6 wt % to 15 wt % based on a total weight of the SPC. In some embodiments, the transition metal halide is present in an amount ranging from 6 wt % to 16 wt % based on a total weight of the SPC. In some embodiments, the transition metal halide is present in an amount ranging from 6 wt % to 17 wt % based on a total weight of the SPC. In some embodiments, the transition metal halide is present in an amount ranging from 6 wt % to 18 wt % based on a total weight of the SPC. In some embodiments, the transition metal halide is present in an amount ranging from 6 wt % to 19 wt % based on a total weight of the SPC. In some embodiments, the transition metal halide is present in an amount ranging from 6 wt % to 20 wt % based on a total weight of the SPC. In some embodiments, the transition metal halide is present in an amount ranging from 7 wt % to 8 wt % based on a total weight of the SPC. In some embodiments, the transition metal halide is present in an amount ranging from 7 wt % to 9 wt % based on a total weight of the SPC. In some embodiments, the transition metal halide is present in an amount ranging from 7 wt % to 10 wt % based on a total weight of the SPC. In some embodiments, the transition metal halide is present in an amount ranging from 7 wt % to 11 wt % based on a total weight of the SPC. In some embodiments, the transition metal halide is present in an amount ranging from 7 wt % to 12 wt % based on a total weight of the SPC. In some embodiments, the transition metal halide is present in an amount ranging from 7 wt % to 13 wt % based on a total weight of the SPC. In some embodiments, the transition metal halide is present in an amount ranging from 7 wt % to 14 wt % based on a total weight of the SPC. In some embodiments, the transition metal halide is present in an amount ranging from 7 wt % to 15 wt % based on a total weight of the SPC. In some embodiments, the transition metal halide is present in an amount ranging from 7 wt % to 16 wt % based on a total weight of the SPC. In some embodiments, the transition metal halide is present in an amount ranging from 7 wt % to 17 wt % based on a total weight of the SPC. In some embodiments, the transition metal halide is present in an amount ranging from 7 wt % to 18 wt % based on a total weight of the SPC. In some embodiments, the transition metal halide is present in an amount ranging from 7 wt % to 19 wt % based on a total weight of the SPC. In some embodiments, the transition metal halide is present in an amount ranging from 7 wt % to 20 wt % based on a total weight of the SPC. In some embodiments, the transition metal halide is present in an amount ranging from 8 wt % to 9 wt % based on a total weight of the SPC. In some embodiments, the transition metal halide is present in an amount ranging from 8 wt % to 10 wt % based on a total weight of the SPC. In some embodiments, the transition metal halide is present in an amount ranging from 8 wt % to 11 wt % based on a total weight of the SPC. In some embodiments, the transition metal halide is present in an amount ranging from 8 wt % to 12 wt % based on a total weight of the SPC. In some embodiments, the transition metal halide is present in an amount ranging from 8 wt % to 13 wt % based on a total weight of the SPC. In some embodiments, the transition metal halide is present in an amount ranging from 8 wt % to 14 wt % based on a total weight of the SPC. In some embodiments, the transition metal halide is present in an amount ranging from 8 wt % to 15 wt % based on a total weight of the SPC. In some embodiments, the transition metal halide is present in an amount ranging from 8 wt % to 16 wt % based on a total weight of the SPC. In some embodiments, the transition metal halide is present in an amount ranging from 8 wt % to 17 wt % based on a total weight of the SPC. In some embodiments, the transition metal halide is present in an amount ranging from 8 wt % to 18 wt % based on a total weight of the SPC. In some embodiments, the transition metal halide is present in an amount ranging from 8 wt % to 19 wt % based on a total weight of the SPC. In some embodiments, the transition metal halide is present in an amount ranging from 8 wt % to 20 wt % based on a total weight of the SPC. In some embodiments, the transition metal halide is present in an amount ranging from 9 wt % to 10 wt % based on a total weight of the SPC. In some embodiments, the transition metal halide is present in an amount ranging from 9 wt % to 11 wt % based on a total weight of the SPC. In some embodiments, the transition metal halide is present in an amount ranging from 9 wt % to 12 wt % based on a total weight of the SPC. In some embodiments, the transition metal halide is present in an amount ranging from 9 wt % to 13 wt % based on a total weight of the SPC. In some embodiments, the transition metal halide is present in an amount ranging from 9 wt % to 14 wt % based on a total weight of the SPC. In some embodiments, the transition metal halide is present in an amount ranging from 9 wt % to 15 wt % based on a total weight of the SPC. In some embodiments, the transition metal halide is present in an amount ranging from 9 wt % to 16 wt % based on a total weight of the SPC. In some embodiments, the transition metal halide is present in an amount ranging from 9 wt % to 17 wt % based on a total weight of the SPC. In some embodiments, the transition metal halide is present in an amount ranging from 9 wt % to 18 wt % based on a total weight of the SPC. In some embodiments, the transition metal halide is present in an amount ranging from 9 wt % to 19 wt % based on a total weight of the SPC. In some embodiments, the transition metal halide is present in an amount ranging from 9 wt % to 20 wt % based on a total weight of the SPC. In some embodiments, the transition metal halide is present in an amount ranging from 10 wt % to 11 wt % based on a total weight of the SPC. In some embodiments, the transition metal halide is present in an amount ranging from 10 wt % to 12 wt % based on a total weight of the SPC. In some embodiments, the transition metal halide is present in an amount ranging from 10 wt % to 13 wt % based on a total weight of the SPC. In some embodiments, the transition metal halide is present in an amount ranging from 10 wt % to 14 wt % based on a total weight of the SPC. In some embodiments, the transition metal halide is present in an amount ranging from 10 wt % to 15 wt % based on a total weight of the SPC. In some embodiments, the transition metal halide is present in an amount ranging from 10 wt % to 16 wt % based on a total weight of the SPC. In some embodiments, the transition metal halide is present in an amount ranging from 10 wt % to 17 wt % based on a total weight of the SPC. In some embodiments, the transition metal halide is present in an amount ranging from 10 wt % to 18 wt % based on a total weight of the SPC. In some embodiments, the transition metal halide is present in an amount ranging from 10 wt % to 19 wt % based on a total weight of the SPC. In some embodiments, the transition metal halide is present in an amount ranging from 10 wt % to 20 wt % based on a total weight of the SPC. In some embodiments, the transition metal halide is present in an amount ranging from 11 wt % to 12 wt % based on a total weight of the SPC. In some embodiments, the transition metal halide is present in an amount ranging from 11 wt % to 13 wt % based on a total weight of the SPC. In some embodiments, the transition metal halide is present in an amount ranging from 11 wt % to 14 wt % based on a total weight of the SPC. In some embodiments, the transition metal halide is present in an amount ranging from 11 wt % to 15 wt % based on a total weight of the SPC. In some embodiments, the transition metal halide is present in an amount ranging from 11 wt % to 16 wt % based on a total weight of the SPC. In some embodiments, the transition metal halide is present in an amount ranging from 11 wt % to 17 wt % based on a total weight of the SPC. In some embodiments, the transition metal halide is present in an amount ranging from 11 wt % to 18 wt % based on a total weight of the SPC. In some embodiments, the transition metal halide is present in an amount ranging from 11 wt % to 19 wt % based on a total weight of the SPC. In some embodiments, the transition metal halide is present in an amount ranging from 11 wt % to 20 wt % based on a total weight of the SPC. In some embodiments, the transition metal halide is present in an amount ranging from 12 wt % to 13 wt % based on a total weight of the SPC. In some embodiments, the transition metal halide is present in an amount ranging from 12 wt % to 14 wt % based on a total weight of the SPC. In some embodiments, the transition metal halide is present in an amount ranging from 12 wt % to 15 wt % based on a total weight of the SPC. In some embodiments, the transition metal halide is present in an amount ranging from 12 wt % to 16 wt % based on a total weight of the SPC. In some embodiments, the transition metal halide is present in an amount ranging from 12 wt % to 17 wt % based on a total weight of the SPC. In some embodiments, the transition metal halide is present in an amount ranging from 12 wt % to 18 wt % based on a total weight of the SPC. In some embodiments, the transition metal halide is present in an amount ranging from 12 wt % to 19 wt % based on a total weight of the SPC. In some embodiments, the transition metal halide is present in an amount ranging from 12 wt % to 20 wt % based on a total weight of the SPC. In some embodiments, the transition metal halide is present in an amount ranging from 13 wt % to 14 wt % based on a total weight of the SPC. In some embodiments, the transition metal halide is present in an amount ranging from 13 wt % to 15 wt % based on a total weight of the SPC. In some embodiments, the transition metal halide is present in an amount ranging from 13 wt % to 16 wt % based on a total weight of the SPC. In some embodiments, the transition metal halide is present in an amount ranging from 13 wt % to 17 wt % based on a total weight of the SPC. In some embodiments, the transition metal halide is present in an amount ranging from 13 wt % to 18 wt % based on a total weight of the SPC. In some embodiments, the transition metal halide is present in an amount ranging from 13 wt % to 19 wt % based on a total weight of the SPC. In some embodiments, the transition metal halide is present in an amount ranging from 13 wt % to 20 wt % based on a total weight of the SPC. In some embodiments, the transition metal halide is present in an amount ranging from 14 wt % to 15 wt % based on a total weight of the SPC. In some embodiments, the transition metal halide is present in an amount ranging from 14 wt % to 16 wt % based on a total weight of the SPC. In some embodiments, the transition metal halide is present in an amount ranging from 14 wt % to 17 wt % based on a total weight of the SPC. In some embodiments, the transition metal halide is present in an amount ranging from 14 wt % to 18 wt % based on a total weight of the SPC. In some embodiments, the transition metal halide is present in an amount ranging from 14 wt % to 19 wt % based on a total weight of the SPC. In some embodiments, the transition metal halide is present in an amount ranging from 14 wt % to 20 wt % based on a total weight of the SPC. In some embodiments, the transition metal halide is present in an amount ranging from 15 wt % to 16 wt % based on a total weight of the SPC. In some embodiments, the transition metal halide is present in an amount ranging from 15 wt % to 17 wt % based on a total weight of the SPC. In some embodiments, the transition metal halide is present in an amount ranging from 15 wt % to 18 wt % based on a total weight of the SPC. In some embodiments, the transition metal halide is present in an amount ranging from 15 wt % to 19 wt % based on a total weight of the SPC. In some embodiments, the transition metal halide is present in an amount ranging from 15 wt % to 20 wt % based on a total weight of the SPC. In some embodiments, the transition metal halide is present in an amount ranging from 16 wt % to 17 wt % based on a total weight of the SPC. In some embodiments, the transition metal halide is present in an amount ranging from 16 wt % to 18 wt % based on a total weight of the SPC. In some embodiments, the transition metal halide is present in an amount ranging from 16 wt % to 19 wt % based on a total weight of the SPC. In some embodiments, the transition metal halide is present in an amount ranging from 16 wt % to 20 wt % based on a total weight of the SPC. In some embodiments, the transition metal halide is present in an amount ranging from 17 wt % to 18 wt % based on a total weight of the SPC. In some embodiments, the transition metal halide is present in an amount ranging from 17 wt % to 19 wt % based on a total weight of the SPC. In some embodiments, the transition metal halide is present in an amount ranging from 17 wt % to 20 wt % based on a total weight of the SPC. In some embodiments, the transition metal halide is present in an amount ranging from 18 wt % to 19 wt % based on a total weight of the SPC. In some embodiments, the transition metal halide is present in an amount ranging from 18 wt % to 20 wt % based on a total weight of the SPC. In some embodiments, the transition metal halide is present in an amount ranging from 19 wt % to 20 wt % based on a total weight of the SPC.

In some embodiments, the SPC comprises sulfur. In some embodiments, the sulfur is present in an amount ranging from 0.1 wt % to 1 wt % based on a total weight of the SPC. In some embodiments, the sulfur is present in an amount ranging from 0.1 wt % to 2 wt % based on a total weight of the SPC. In some embodiments, the sulfur is present in an amount ranging from 0.1 wt % to 3 wt % based on a total weight of the SPC. In some embodiments, the sulfur is present in an amount ranging from 0.1 wt % to 4 wt % based on a total weight of the SPC. In some embodiments, the sulfur is present in an amount ranging from 0.1 wt % to 5 wt % based on a total weight of the SPC. In some embodiments, the sulfur is present in an amount ranging from 0.1 wt % to 6 wt % based on a total weight of the SPC. In some embodiments, the sulfur is present in an amount ranging from 0.1 wt % to 7 wt % based on a total weight of the SPC. In some embodiments, the sulfur is present in an amount ranging from 0.1 wt % to 8 wt % based on a total weight of the SPC. In some embodiments, the sulfur is present in an amount ranging from 0.1 wt % to 9 wt % based on a total weight of the SPC. In some embodiments, the sulfur is present in an amount ranging from 0.1 wt % to 10 wt % based on a total weight of the SPC. In some embodiments, the sulfur is present in an amount ranging from 0.1 wt % to 11 wt % based on a total weight of the SPC. In some embodiments, the sulfur is present in an amount ranging from 0.1 wt % to 12 wt % based on a total weight of the SPC. In some embodiments, the sulfur is present in an amount ranging from 0.1 wt % to 13 wt % based on a total weight of the SPC. In some embodiments, the sulfur is present in an amount ranging from 0.1 wt % to 14 wt % based on a total weight of the SPC. In some embodiments, the sulfur is present in an amount ranging from 0.1 wt % to 15 wt % based on a total weight of the SPC. In some embodiments, the sulfur is present in an amount ranging from 0.1 wt % to 16 wt % based on a total weight of the SPC. In some embodiments, the sulfur is present in an amount ranging from 0.1 wt % to 17 wt % based on a total weight of the SPC. In some embodiments, the sulfur is present in an amount ranging from 0.1 wt % to 18 wt % based on a total weight of the SPC. In some embodiments, the sulfur is present in an amount ranging from 0.1 wt % to 19 wt % based on a total weight of the SPC. In some embodiments, the sulfur is present in an amount ranging from 0.1 wt % to 20 wt % based on a total weight of the SPC. In some embodiments, the sulfur is present in an amount ranging from 1 wt % to 2 wt % based on a total weight of the SPC. In some embodiments, the sulfur is present in an amount ranging from 1 wt % to 3 wt % based on a total weight of the SPC. In some embodiments, the sulfur is present in an amount ranging from 1 wt % to 4 wt % based on a total weight of the SPC. In some embodiments, the sulfur is present in an amount ranging from 1 wt % to 5 wt % based on a total weight of the SPC. In some embodiments, the sulfur is present in an amount ranging from 1 wt % to 6 wt % based on a total weight of the SPC. In some embodiments, the sulfur is present in an amount ranging from 1 wt % to 7 wt % based on a total weight of the SPC. In some embodiments, the sulfur is present in an amount ranging from 1 wt % to 8 wt % based on a total weight of the SPC. In some embodiments, the sulfur is present in an amount ranging from 1 wt % to 9 wt % based on a total weight of the SPC. In some embodiments, the sulfur is present in an amount ranging from 1 wt % to 10 wt % based on a total weight of the SPC. In some embodiments, the sulfur is present in an amount ranging from 1 wt % to 11 wt % based on a total weight of the SPC. In some embodiments, the sulfur is present in an amount ranging from 1 wt % to 12 wt % based on a total weight of the SPC. In some embodiments, the sulfur is present in an amount ranging from 1 wt % to 13 wt % based on a total weight of the SPC. In some embodiments, the sulfur is present in an amount ranging from 1 wt % to 14 wt % based on a total weight of the SPC. In some embodiments, the sulfur is present in an amount ranging from 1 wt % to 15 wt % based on a total weight of the SPC. In some embodiments, the sulfur is present in an amount ranging from 1 wt % to 16 wt % based on a total weight of the SPC. In some embodiments, the sulfur is present in an amount ranging from 1 wt % to 17 wt % based on a total weight of the SPC. In some embodiments, the sulfur is present in an amount ranging from 1 wt % to 18 wt % based on a total weight of the SPC. In some embodiments, the sulfur is present in an amount ranging from 1 wt % to 19 wt % based on a total weight of the SPC. In some embodiments, the sulfur is present in an amount ranging from 1 wt % to 20 wt % based on a total weight of the SPC. In some embodiments, the sulfur is present in an amount ranging from 2 wt % to 3 wt % based on a total weight of the SPC. In some embodiments, the sulfur is present in an amount ranging from 2 wt % to 4 wt % based on a total weight of the SPC. In some embodiments, the sulfur is present in an amount ranging from 2 wt % to 5 wt % based on a total weight of the SPC. In some embodiments, the sulfur is present in an amount ranging from 2 wt % to 6 wt % based on a total weight of the SPC. In some embodiments, the sulfur is present in an amount ranging from 2 wt % to 7 wt % based on a total weight of the SPC. In some embodiments, the sulfur is present in an amount ranging from 2 wt % to 8 wt % based on a total weight of the SPC. In some embodiments, the sulfur is present in an amount ranging from 2 wt % to 9 wt % based on a total weight of the SPC. In some embodiments, the sulfur is present in an amount ranging from 2 wt % to 10 wt % based on a total weight of the SPC. In some embodiments, the sulfur is present in an amount ranging from 2 wt % to 11 wt % based on a total weight of the SPC. In some embodiments, the sulfur is present in an amount ranging from 2 wt % to 12 wt % based on a total weight of the SPC. In some embodiments, the sulfur is present in an amount ranging from 2 wt % to 13 wt % based on a total weight of the SPC. In some embodiments, the sulfur is present in an amount ranging from 2 wt % to 14 wt % based on a total weight of the SPC. In some embodiments, the sulfur is present in an amount ranging from 2 wt % to 15 wt % based on a total weight of the SPC. In some embodiments, the sulfur is present in an amount ranging from 2 wt % to 16 wt % based on a total weight of the SPC. In some embodiments, the sulfur is present in an amount ranging from 2 wt % to 17 wt % based on a total weight of the SPC. In some embodiments, the sulfur is present in an amount ranging from 2 wt % to 18 wt % based on a total weight of the SPC. In some embodiments, the sulfur is present in an amount ranging from 2 wt % to 19 wt % based on a total weight of the SPC. In some embodiments, the sulfur is present in an amount ranging from 2 wt % to 20 wt % based on a total weight of the SPC. In some embodiments, the sulfur is present in an amount ranging from 3 wt % to 4 wt % based on a total weight of the SPC. In some embodiments, the sulfur is present in an amount ranging from 3 wt % to 5 wt % based on a total weight of the SPC. In some embodiments, the sulfur is present in an amount ranging from 3 wt % to 6 wt % based on a total weight of the SPC. In some embodiments, the sulfur is present in an amount ranging from 3 wt % to 7 wt % based on a total weight of the SPC. In some embodiments, the sulfur is present in an amount ranging from 3 wt % to 8 wt % based on a total weight of the SPC. In some embodiments, the sulfur is present in an amount ranging from 3 wt % to 9 wt % based on a total weight of the SPC. In some embodiments, the sulfur is present in an amount ranging from 3 wt % to 10 wt % based on a total weight of the SPC. In some embodiments, the sulfur is present in an amount ranging from 3 wt % to 11 wt % based on a total weight of the SPC. In some embodiments, the sulfur is present in an amount ranging from 3 wt % to 12 wt % based on a total weight of the SPC. In some embodiments, the sulfur is present in an amount ranging from 3 wt % to 13 wt % based on a total weight of the SPC. In some embodiments, the sulfur is present in an amount ranging from 3 wt % to 14 wt % based on a total weight of the SPC. In some embodiments, the sulfur is present in an amount ranging from 3 wt % to 15 wt % based on a total weight of the SPC. In some embodiments, the sulfur is present in an amount ranging from 3 wt % to 16 wt % based on a total weight of the SPC. In some embodiments, the sulfur is present in an amount ranging from 3 wt % to 17 wt % based on a total weight of the SPC. In some embodiments, the sulfur is present in an amount ranging from 3 wt % to 18 wt % based on a total weight of the SPC. In some embodiments, the sulfur is present in an amount ranging from 3 wt % to 19 wt % based on a total weight of the SPC. In some embodiments, the sulfur is present in an amount ranging from 3 wt % to 20 wt % based on a total weight of the SPC. In some embodiments, the sulfur is present in an amount ranging from 4 wt % to 5 wt % based on a total weight of the SPC. In some embodiments, the sulfur is present in an amount ranging from 4 wt % to 6 wt % based on a total weight of the SPC. In some embodiments, the sulfur is present in an amount ranging from 4 wt % to 7 wt % based on a total weight of the SPC. In some embodiments, the sulfur is present in an amount ranging from 4 wt % to 8 wt % based on a total weight of the SPC. In some embodiments, the sulfur is present in an amount ranging from 4 wt % to 9 wt % based on a total weight of the SPC. In some embodiments, the sulfur is present in an amount ranging from 4 wt % to 10 wt % based on a total weight of the SPC. In some embodiments, the sulfur is present in an amount ranging from 4 wt % to 11 wt % based on a total weight of the SPC. In some embodiments, the sulfur is present in an amount ranging from 4 wt % to 12 wt % based on a total weight of the SPC. In some embodiments, the sulfur is present in an amount ranging from 4 wt % to 13 wt % based on a total weight of the SPC. In some embodiments, the sulfur is present in an amount ranging from 4 wt % to 14 wt % based on a total weight of the SPC. In some embodiments, the sulfur is present in an amount ranging from 4 wt % to 15 wt % based on a total weight of the SPC. In some embodiments, the sulfur is present in an amount ranging from 4 wt % to 16 wt % based on a total weight of the SPC. In some embodiments, the sulfur is present in an amount ranging from 4 wt % to 17 wt % based on a total weight of the SPC. In some embodiments, the sulfur is present in an amount ranging from 4 wt % to 18 wt % based on a total weight of the SPC. In some embodiments, the sulfur is present in an amount ranging from 4 wt % to 19 wt % based on a total weight of the SPC. In some embodiments, the sulfur is present in an amount ranging from 4 wt % to 20 wt % based on a total weight of the SPC. In some embodiments, the sulfur is present in an amount ranging from 5 wt % to 6 wt % based on a total weight of the SPC. In some embodiments, the sulfur is present in an amount ranging from 5 wt % to 7 wt % based on a total weight of the SPC. In some embodiments, the sulfur is present in an amount ranging from 5 wt % to 8 wt % based on a total weight of the SPC. In some embodiments, the sulfur is present in an amount ranging from 5 wt % to 9 wt % based on a total weight of the SPC. In some embodiments, the sulfur is present in an amount ranging from 5 wt % to 10 wt % based on a total weight of the SPC. In some embodiments, the sulfur is present in an amount ranging from 5 wt % to 11 wt % based on a total weight of the SPC. In some embodiments, the sulfur is present in an amount ranging from 5 wt % to 12 wt % based on a total weight of the SPC. In some embodiments, the sulfur is present in an amount ranging from 5 wt % to 13 wt % based on a total weight of the SPC. In some embodiments, the sulfur is present in an amount ranging from 5 wt % to 14 wt % based on a total weight of the SPC. In some embodiments, the sulfur is present in an amount ranging from 5 wt % to 15 wt % based on a total weight of the SPC. In some embodiments, the sulfur is present in an amount ranging from 5 wt % to 16 wt % based on a total weight of the SPC. In some embodiments, the sulfur is present in an amount ranging from 5 wt % to 17 wt % based on a total weight of the SPC. In some embodiments, the sulfur is present in an amount ranging from 5 wt % to 18 wt % based on a total weight of the SPC. In some embodiments, the sulfur is present in an amount ranging from 5 wt % to 19 wt % based on a total weight of the SPC. In some embodiments, the sulfur is present in an amount ranging from 5 wt % to 20 wt % based on a total weight of the SPC. In some embodiments, the sulfur is present in an amount ranging from 6 wt % to 7 wt % based on a total weight of the SPC. In some embodiments, the sulfur is present in an amount ranging from 6 wt % to 8 wt % based on a total weight of the SPC. In some embodiments, the sulfur is present in an amount ranging from 6 wt % to 9 wt % based on a total weight of the SPC. In some embodiments, the sulfur is present in an amount ranging from 6 wt % to 10 wt % based on a total weight of the SPC. In some embodiments, the sulfur is present in an amount ranging from 6 wt % to 11 wt % based on a total weight of the SPC. In some embodiments, the sulfur is present in an amount ranging from 6 wt % to 12 wt % based on a total weight of the SPC. In some embodiments, the sulfur is present in an amount ranging from 6 wt % to 13 wt % based on a total weight of the SPC. In some embodiments, the sulfur is present in an amount ranging from 6 wt % to 14 wt % based on a total weight of the SPC. In some embodiments, the sulfur is present in an amount ranging from 6 wt % to 15 wt % based on a total weight of the SPC. In some embodiments, the sulfur is present in an amount ranging from 6 wt % to 16 wt % based on a total weight of the SPC. In some embodiments, the sulfur is present in an amount ranging from 6 wt % to 17 wt % based on a total weight of the SPC. In some embodiments, the sulfur is present in an amount ranging from 6 wt % to 18 wt % based on a total weight of the SPC. In some embodiments, the sulfur is present in an amount ranging from 6 wt % to 19 wt % based on a total weight of the SPC. In some embodiments, the sulfur is present in an amount ranging from 6 wt % to 20 wt % based on a total weight of the SPC. In some embodiments, the sulfur is present in an amount ranging from 7 wt % to 8 wt % based on a total weight of the SPC. In some embodiments, the sulfur is present in an amount ranging from 7 wt % to 9 wt % based on a total weight of the SPC. In some embodiments, the sulfur is present in an amount ranging from 7 wt % to 10 wt % based on a total weight of the SPC. In some embodiments, the sulfur is present in an amount ranging from 7 wt % to 11 wt % based on a total weight of the SPC. In some embodiments, the sulfur is present in an amount ranging from 7 wt % to 12 wt % based on a total weight of the SPC. In some embodiments, the sulfur is present in an amount ranging from 7 wt % to 13 wt % based on a total weight of the SPC. In some embodiments, the sulfur is present in an amount ranging from 7 wt % to 14 wt % based on a total weight of the SPC. In some embodiments, the sulfur is present in an amount ranging from 7 wt % to 15 wt % based on a total weight of the SPC. In some embodiments, the sulfur is present in an amount ranging from 7 wt % to 16 wt % based on a total weight of the SPC. In some embodiments, the sulfur is present in an amount ranging from 7 wt % to 17 wt % based on a total weight of the SPC. In some embodiments, the sulfur is present in an amount ranging from 7 wt % to 18 wt % based on a total weight of the SPC. In some embodiments, the sulfur is present in an amount ranging from 7 wt % to 19 wt % based on a total weight of the SPC. In some embodiments, the sulfur is present in an amount ranging from 7 wt % to 20 wt % based on a total weight of the SPC. In some embodiments, the sulfur is present in an amount ranging from 8 wt % to 9 wt % based on a total weight of the SPC. In some embodiments, the sulfur is present in an amount ranging from 8 wt % to 10 wt % based on a total weight of the SPC. In some embodiments, the sulfur is present in an amount ranging from 8 wt % to 11 wt % based on a total weight of the SPC. In some embodiments, the sulfur is present in an amount ranging from 8 wt % to 12 wt % based on a total weight of the SPC. In some embodiments, the sulfur is present in an amount ranging from 8 wt % to 13 wt % based on a total weight of the SPC. In some embodiments, the sulfur is present in an amount ranging from 8 wt % to 14 wt % based on a total weight of the SPC. In some embodiments, the sulfur is present in an amount ranging from 8 wt % to 15 wt % based on a total weight of the SPC. In some embodiments, the sulfur is present in an amount ranging from 8 wt % to 16 wt % based on a total weight of the SPC. In some embodiments, the sulfur is present in an amount ranging from 8 wt % to 17 wt % based on a total weight of the SPC. In some embodiments, the sulfur is present in an amount ranging from 8 wt % to 18 wt % based on a total weight of the SPC. In some embodiments, the sulfur is present in an amount ranging from 8 wt % to 19 wt % based on a total weight of the SPC. In some embodiments, the sulfur is present in an amount ranging from 8 wt % to 20 wt % based on a total weight of the SPC. In some embodiments, the sulfur is present in an amount ranging from 9 wt % to 10 wt % based on a total weight of the SPC. In some embodiments, the sulfur is present in an amount ranging from 9 wt % to 11 wt % based on a total weight of the SPC. In some embodiments, the sulfur is present in an amount ranging from 9 wt % to 12 wt % based on a total weight of the SPC. In some embodiments, the sulfur is present in an amount ranging from 9 wt % to 13 wt % based on a total weight of the SPC. In some embodiments, the sulfur is present in an amount ranging from 9 wt % to 14 wt % based on a total weight of the SPC. In some embodiments, the sulfur is present in an amount ranging from 9 wt % to 15 wt % based on a total weight of the SPC. In some embodiments, the sulfur is present in an amount ranging from 9 wt % to 16 wt % based on a total weight of the SPC. In some embodiments, the sulfur is present in an amount ranging from 9 wt % to 17 wt % based on a total weight of the SPC. In some embodiments, the sulfur is present in an amount ranging from 9 wt % to 18 wt % based on a total weight of the SPC. In some embodiments, the sulfur is present in an amount ranging from 9 wt % to 19 wt % based on a total weight of the SPC. In some embodiments, the sulfur is present in an amount ranging from 9 wt % to 20 wt % based on a total weight of the SPC. In some embodiments, the sulfur is present in an amount ranging from 10 wt % to 11 wt % based on a total weight of the SPC. In some embodiments, the sulfur is present in an amount ranging from 10 wt % to 12 wt % based on a total weight of the SPC. In some embodiments, the sulfur is present in an amount ranging from 10 wt % to 13 wt % based on a total weight of the SPC. In some embodiments, the sulfur is present in an amount ranging from 10 wt % to 14 wt % based on a total weight of the SPC. In some embodiments, the sulfur is present in an amount ranging from 10 wt % to 15 wt % based on a total weight of the SPC. In some embodiments, the sulfur is present in an amount ranging from 10 wt % to 16 wt % based on a total weight of the SPC. In some embodiments, the sulfur is present in an amount ranging from 10 wt % to 17 wt % based on a total weight of the SPC. In some embodiments, the sulfur is present in an amount ranging from 10 wt % to 18 wt % based on a total weight of the SPC. In some embodiments, the sulfur is present in an amount ranging from 10 wt % to 19 wt % based on a total weight of the SPC. In some embodiments, the sulfur is present in an amount ranging from 10 wt % to 20 wt % based on a total weight of the SPC. In some embodiments, the sulfur is present in an amount ranging from 11 wt % to 12 wt % based on a total weight of the SPC. In some embodiments, the sulfur is present in an amount ranging from 11 wt % to 13 wt % based on a total weight of the SPC. In some embodiments, the sulfur is present in an amount ranging from 11 wt % to 14 wt % based on a total weight of the SPC. In some embodiments, the sulfur is present in an amount ranging from 11 wt % to 15 wt % based on a total weight of the SPC. In some embodiments, the sulfur is present in an amount ranging from 11 wt % to 16 wt % based on a total weight of the SPC. In some embodiments, the sulfur is present in an amount ranging from 11 wt % to 17 wt % based on a total weight of the SPC. In some embodiments, the sulfur is present in an amount ranging from 11 wt % to 18 wt % based on a total weight of the SPC. In some embodiments, the sulfur is present in an amount ranging from 11 wt % to 19 wt % based on a total weight of the SPC. In some embodiments, the sulfur is present in an amount ranging from 11 wt % to 20 wt % based on a total weight of the SPC. In some embodiments, the sulfur is present in an amount ranging from 12 wt % to 13 wt % based on a total weight of the SPC. In some embodiments, the sulfur is present in an amount ranging from 12 wt % to 14 wt % based on a total weight of the SPC. In some embodiments, the sulfur is present in an amount ranging from 12 wt % to 15 wt % based on a total weight of the SPC. In some embodiments, the sulfur is present in an amount ranging from 12 wt % to 16 wt % based on a total weight of the SPC. In some embodiments, the sulfur is present in an amount ranging from 12 wt % to 17 wt % based on a total weight of the SPC. In some embodiments, the sulfur is present in an amount ranging from 12 wt % to 18 wt % based on a total weight of the SPC. In some embodiments, the sulfur is present in an amount ranging from 12 wt % to 19 wt % based on a total weight of the SPC. In some embodiments, the sulfur is present in an amount ranging from 12 wt % to 20 wt % based on a total weight of the SPC. In some embodiments, the sulfur is present in an amount ranging from 13 wt % to 14 wt % based on a total weight of the SPC. In some embodiments, the sulfur is present in an amount ranging from 13 wt % to 15 wt % based on a total weight of the SPC. In some embodiments, the sulfur is present in an amount ranging from 13 wt % to 16 wt % based on a total weight of the SPC. In some embodiments, the sulfur is present in an amount ranging from 13 wt % to 17 wt % based on a total weight of the SPC. In some embodiments, the sulfur is present in an amount ranging from 13 wt % to 18 wt % based on a total weight of the SPC. In some embodiments, the sulfur is present in an amount ranging from 13 wt % to 19 wt % based on a total weight of the SPC. In some embodiments, the sulfur is present in an amount ranging from 13 wt % to 20 wt % based on a total weight of the SPC. In some embodiments, the sulfur is present in an amount ranging from 14 wt % to 15 wt % based on a total weight of the SPC. In some embodiments, the sulfur is present in an amount ranging from 14 wt % to 16 wt % based on a total weight of the SPC. In some embodiments, the sulfur is present in an amount ranging from 14 wt % to 17 wt % based on a total weight of the SPC. In some embodiments, the sulfur is present in an amount ranging from 14 wt % to 18 wt % based on a total weight of the SPC. In some embodiments, the sulfur is present in an amount ranging from 14 wt % to 19 wt % based on a total weight of the SPC. In some embodiments, the sulfur is present in an amount ranging from 14 wt % to 20 wt % based on a total weight of the SPC. In some embodiments, the sulfur is present in an amount ranging from 15 wt % to 16 wt % based on a total weight of the SPC. In some embodiments, the sulfur is present in an amount ranging from 15 wt % to 17 wt % based on a total weight of the SPC. In some embodiments, the sulfur is present in an amount ranging from 15 wt % to 18 wt % based on a total weight of the SPC. In some embodiments, the sulfur is present in an amount ranging from 15 wt % to 19 wt % based on a total weight of the SPC. In some embodiments, the sulfur is present in an amount ranging from 15 wt % to 20 wt % based on a total weight of the SPC. In some embodiments, the sulfur is present in an amount ranging from 16 wt % to 17 wt % based on a total weight of the SPC. In some embodiments, the sulfur is present in an amount ranging from 16 wt % to 18 wt % based on a total weight of the SPC. In some embodiments, the sulfur is present in an amount ranging from 16 wt % to 19 wt % based on a total weight of the SPC. In some embodiments, the sulfur is present in an amount ranging from 16 wt % to 20 wt % based on a total weight of the SPC. In some embodiments, the sulfur is present in an amount ranging from 17 wt % to 18 wt % based on a total weight of the SPC. In some embodiments, the sulfur is present in an amount ranging from 17 wt % to 19 wt % based on a total weight of the SPC. In some embodiments, the sulfur is present in an amount ranging from 17 wt % to 20 wt % based on a total weight of the SPC. In some embodiments, the sulfur is present in an amount ranging from 18 wt % to 19 wt % based on a total weight of the SPC. In some embodiments, the sulfur is present in an amount ranging from 18 wt % to 20 wt % based on a total weight of the SPC. In some embodiments, the sulfur is present in an amount ranging from 19 wt % to 20 wt % based on a total weight of the SPC.

In some embodiments, the transition metal halide comprises silver (Ag). In some embodiments, the transition metal halide comprises iodine (I). In some embodiments, the transition metal halide comprises silver iodide (AgI). In some embodiments, the sorbent comprises activated carbon.

In some embodiments, a solution of a non-halide salt of a transition metal is prepared or obtained, and the non-halide salt of the transition metal is applied to a sorbent to incorporate the non-halide salt of the transition metal within a microstructure of the sorbent. Then, a non-transition metal halide is applied to the sorbent, so as to react the non-transition metal halide with the non-halide salt of the transition metal. This reaction results in and forms a transition metal halide within the microstructure of the sorbent.

In order to measure the isotherm and determine the Langmuir isotherm parameters, qₘ and B, salts of a non-halide salt of a transition metal solutions can be prepared with certain predetermined concentrations. The sorbent samples can be cut into small pieces and wetted with alcohol. Each of the wetted samples can then be soaked into each of the prepared solutions at a particular temperature. After some time, the samples are dried and the transition metal content can be quantified using Energy-dispersive X-ray spectroscopy (EDX) of SEM (scanning electron micrograph) images of the dried samples. EDX is an analytical technique in which an electron beam hits a sample and produces an energetic shift in the electrons of the sample. This shift causes the sample to emit an X-ray signature which allows for identification of the elemental composition of the sample. The signal is observed in an image of the sample with the light intensity reflecting the relative concentration of the target component. The resulting data can be plotted on a graph of the transition metal content versus the non-halide salt of a transition metal concentration in the liquid solution and can be fitted to a Langmuir isotherm according to:

$$θ = \frac{q}{{q}_{m}} = \frac{B * C}{1 + B * C}$$

The Langmuir p parameters, qₘ and B, are extracted from the curve fit.

In some embodiments, the application is characterized by the following formula:

transition metal non-halide salt+non-transition metal halide→transition metal halide+non-transition metal non-halide salt

In some embodiments, the application is characterized by the following formula:

$${AgNO}_{3} + KI \to AgI + {KNO}_{3} .$$

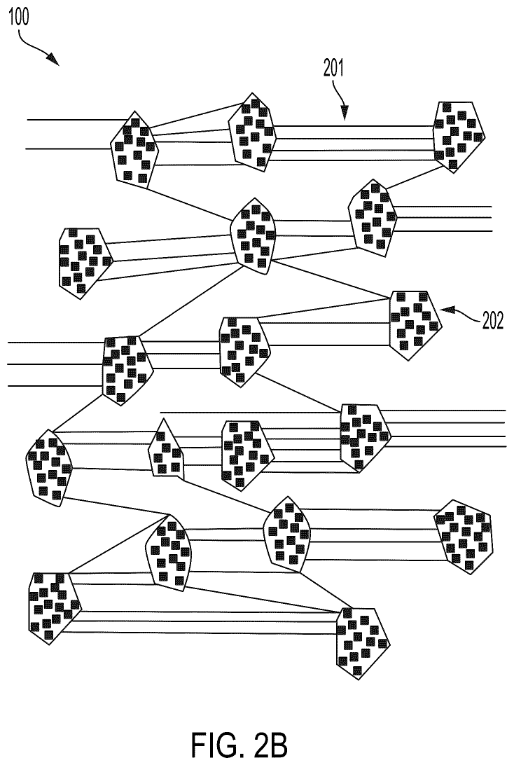

According to some embodiments, AgI is to be integrated into a microstructure of the sorbent (e.g., carbon of the sorbent). However, AgI isn't readily soluble to easily accomplish this integration. As shown in FIGS. 3-5, embodiments of methods to accomplish this integration of AgI are disclosed. In some embodiments, a chemical reaction within the carbon microstructure is used to integrate AgI into the sorbent's microstructure. The chemical reaction transports both reagents, a transition metal non-halide salt and a non-transition metal halide to the carbon. In some embodiments, the chemical reaction includes selecting a soluble transition metal non-halide salt. In some embodiments, silver nitrate (AgNO₃) is chosen as a “water-soluble” transition non-halide metal salt. The high-water solubility of AgNO₃ can be critical to the chemical reaction, in some embodiments.

In some embodiments, the transition metal non-halide salt is mixed with a solvent (e.g., water to AgNO₃) and applied to a carbon microstructure of the sorbent. AgNO₃ may not simply be imbibed into the microstructure, and it can be strongly adsorbed to the sorbent. This can enhance the subsequent chemical reaction with KI on the surface of the microstructure of the carbon (instead of reaction within the solvent, where at least some of the produced AgI might result outside of the carbon microstructure).

KI is an example of a non-transition metal halide. A property of the non-transition metal halide according to some embodiments includes the non-transition metal halide being a “water-soluble halide” species that can be transported to the microstructure of the carbon of the sorbent, where it can subsequently react with the adsorbed AgNO₃. In some examples, the “non-transition metal halide” group of materials comprises ammonium, Group I, or Group II halides. These salts are all water soluble or soluble in alcohol (e.g., methanol, ethanol, or a combination thereof). In some embodiments, a consideration in the selection of the cation can be that the halide salt of that cation is soluble in water or in alcohol (e.g., methanol, ethanol, or a combination thereof). Another consideration according to some embodiments can be the solubility of the byproduct (e.g., in this example, the byproduct being KNO₃). KNO₃ is a “byproduct” of the above-described chemical reaction. KNO₃ is soluble, as are virtually all nitrates. Accordingly, the “byproduct” may be easily removed by washing, or simply by dissolving in the acid formed in the SPC during operation. The composition of the “non-transition metal salt” is dependent on the reagents used.

In some embodiments, AgI is the “product” of the above-mentioned chemical reaction. In some embodiments, AgI is the transition metal halide. AgI is insoluble in water and cannot be extracted from the microstructure of the carbon using water as the solvent.

The above embodiments react rapidly (virtually instantaneously) and the incorporation into the microstructure of SPC containing sulfur results in a significant boost to mercury capture efficiency.

FIG. 3 depicts a flowchart according to some embodiments of a method 300, which comprises obtaining 302 a sorbent polymer composite (SPC), wherein the SPC comprises a polymer and a sorbent; obtaining 304 a non-halide salt of a transition metal; obtaining 306 a non-transition metal halide. These steps 302, 304, 306 can be accomplished in any sequential order. The method 300 further comprises applying 308 the non-halide salt of the transition metal to the sorbent, so as to incorporate the non-halide salt of the transition metal within a microstructure of the sorbent; and then applying 310 the non-transition metal halide to the sorbent (after step 308), so as to react the non-transition metal halide with the non-halide salt of the transition metal that is incorporated within the microstructure of the sorbent, thereby forming a transition metal halide within the microstructure of the sorbent.

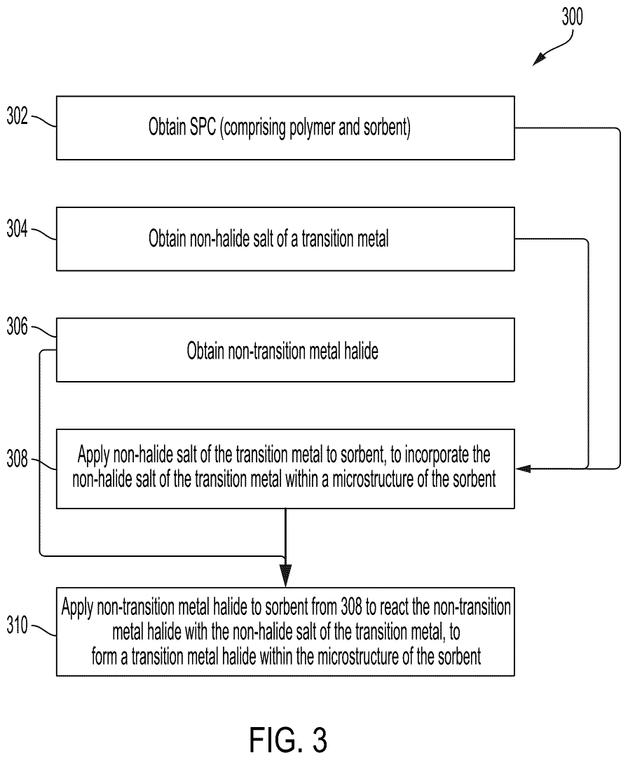

FIG. 4 depicts another flowchart according to some embodiments, and method 400 further comprises in addition to the method 300 shown in FIG. 3, wherein a non-transition metal salt which is also formed within the microstructure of the sorbent, and thus the method 400 further comprises removing 402 the non-transition metal salt from the sorbent.

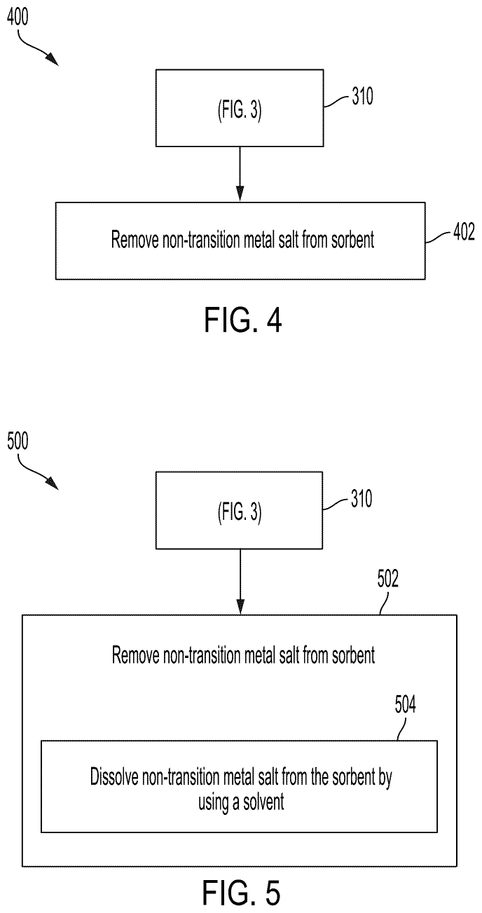

FIG. 5 depicts another flowchart according to some embodiments, and method 500 further comprises in addition to the method 300 shown in FIG. 3, wherein a non-transition metal salt which is also formed within the microstructure of the sorbent, and thus the method 500 further comprises removing 502 the non-transition metal salt from the sorbent, wherein the removing 502 the non-transition metal salt from the sorbent comprises dissolving 504 the non-transition metal salt from the sorbent using a solvent.

In some embodiments of the SPC, silver iodide loaded carbon can be prepared by introducing a silver nitrate solution to the carbon, where silver nitrate molecules will be absorbed onto the carbon. Subsequently, a potassium iodide solution can be introduced to the carbon, where silver nitrate molecules on the carbon pores interact with potassium iodide molecules according to the following reaction:

$${AgNO}_{3} + KI \to AgI + {KNO}_{3}$$

The above reaction can be kinetically fast (near instant). After the reaction, AgI and KNO₃ will be formed on or within carbon pores. Then, because KNO₃ is water soluble, KNO₃ can be washed out or away from the carbon using water, as needed or as necessary.

The following examples are provided to ensure that the operational functionalities of the various embodiments disclosed herein are appreciated. The scopes of protection are not necessarily limited by the various examples provided below.

### Loading Method Examples

### Loading Method Example: AgI Loading Method 1

In a nonlimiting example, a first solution was prepared by mixing 0.724 g silver nitrate (AgNO₃) with 15 mL of deionized (DI) water. A second solution was prepared by mixing 0.707 g potassium iodide (KI) with 15 mL of DI water. The amounts of AgNO₃ and KI were calculated to achieve a 1 wt % AgI loading on carbon powder. For achieving other wt % loading amounts, the amount of silver nitrate and potassium iodide can be adjusted. 100 g of activated carbon powder was placed into a tumbler drum reactor chamber and tumbled at 50 rpm. The first solution containing silver nitrate was slowly sprayed onto the carbon during the tumbling of the carbon powder. After about 10 minutes of tumbling, the second solution containing potassium iodide was slowly sprayed onto the carbon. The tumbler drum reactor chamber was tumbled for an additional 20 minutes after application of both solutions. The carbon powder was then removed from the impregnation chamber and dried in an oven at 100° C. for 24 hours.

### Loading Method Example: AgI Loading Method 2

In another nonlimiting example, a first solution was prepared by mixing 7.24 g silver nitrate (AgNO₃) with 1800 mL of DI water and a second solution was prepared by mixing 7.07 g potassium iodide (KI) with 800 mL of DI water. The amount of AgNO₃ and KI were calculated to achieve a 1 wt % AgI loading on carbon powder. For achieving other wt % loading amounts, the amount of silver nitrate and potassium iodide can be adjusted. 1 kg of activated carbon powder was placed into a reaction chamber. The first solution containing silver nitrate was slowly added into the reaction chamber while continuously stirring. After an additional 60 minutes of stirring, the second solution containing potassium iodide was slowly added into the reaction chamber while continuously stirring. The reaction chamber was stirred for an additional 60 minutes after application of both solutions. The stirrer was turned off and the carbon was allowed to settle for 3 hours. The excess water was then decanted from the slurry and the carbon powder was dried in an oven at 100° C. for 24 hours.

### Loading Method Example: AgI Loading Method 3:

In yet another nonlimiting example, 100 g of dry activated carbon powder was mixed with 1 g AgI powder to form a 1 wt % AgI loading on the carbon powder. The amount of AgI was calculated to achieve a 1 wt % AgI loading on carbon powder. The amounts of AgI and dry activated carbon powder can be adjusted accordingly for other desired amounts.

### Langmuir Isotherm Determination Example

In a nonlimiting example, several silver nitrate (AgNO₃) solutions were prepared with concentrations from 0 to 100 mmole/L. SPC samples were cut into disks with 5 mm diameter and wetted with alcohol. The wetted samples were soaked into AgNO₃ solutions, one for each solution, at room temperature. After two days, the samples were dried at 100° C. for 2 hours and the silver content was quantified using EDX from SEM images of the dried samples. The average of the silver content from three SEM images were averaged as the silver content for the sample soaked in that particular AgNO₃ solution. The resulting data was be plotted on a graph of silver content versus silver nitrate concentration in the liquid solution and fitted to a Langmuir isotherm according to the above equation, and the Langmuir parameters, qₘ and B, were extracted from the curve fit.

Nonlimiting exemplary tests for mercury vapor removal were performed to determine the efficacy of the disclosed embodiments. In the performance of these tests, a nonlimiting testing apparatus was used, wherein the testing apparatus included, for example:
(1) a supply of air regulated by a mass flow controller;
(2) a mercury source produced by means a small nitrogen purge through of a DYNACALIBRATOR Calibration Gas Generators (VICI Metronics, Inc., Poulsbo, WA, USA), comprising a mercury permeation tube;
(3) SO₂ was obtained from a 2% SO₂ gas mixture in nitrogen, regulated through a mass flow controller; and
(4) a 300 mm triangular sample cell with 12 mm side length fitted with a bypass, and located in an oven maintained at 60° C.
(5) mercury detection by means of Tekran 3300 Mercury Analyzer (Tekran Instruments Corporation, Toronto, Canada), which is able to measure total, elemental, and ionic mercury concentration; and
(6) a SO₂ analyzer by means of Teledyne Model T100H high range UV fluorescence SO₂ analyzer (Teledyne API, CA, USA).

Removal Efficiency (e.g., % Efficiency) can be determined as the difference between inlet levels (bypassing the sample; Concentration(inlet)) and outlet levels (passing through the sample; Concentration(outlet)). Percent efficiency (% Efficiency) is defined as follows:

$$\% Efficiency = 100 \times [ Concentration ( inlet ) - Concentration ( outlet ) ] / [ Concentration ( inlet ) ]$$

Nonlimiting exemplary tests for exposure to flue gas were performed. The exposure to flue gas can be simulated using a test apparatus, which can include, for example, the following:
(1) a supply of air regulated by a mass flow controller;
(2) SO₂ was obtained from a 1% SO₂ gas mixture in nitrogen, regulated through a mass flow controller;
(3) a 300 mm triangular sample cell with 12 mm side length fitted with a bypass, and located in an oven maintained at 55° C.;
(4) while maintaining a high relative humidity of over 80% by means of an MH-070 permeation tube humidifier (PermaPure, NJ, USA) located external to the oven.

To determine the Removal Efficiencies of the various exemplary samples, the samples were exposed to a simulated flue gas stream containing 785 mg/m³ of SO₂ and a humidity of 90%, with the total air flow rate at 1 standard liters/min.

Approximately once per month (e.g., every 30 days), a sample was taken and analyzed by X-ray Fluorescence (“XRF”) for iodine content. The iodine content was tracked over time.

Nonlimiting exemplary tests for flue gas durability were performed by exposing various samples to an effluent gas from a slipstream of a wet flue gas desulfurization absorber unit on a coal fire powered plant. Various test samples were exposed to the flue gas in, for example and not limited to, up to two configurations.

In the first configuration, up to six 3.5″×12″ (8.89 cm×30.48 cm) sheets of SPC samples were supported on rods to enable unimpeded flow across the sheets were installed into a 3.5″×3.5″×40″ (8.89 cm×8.89 cm×101 cm) insulated sample fixture.

The samples were exposed by pulling approximately 80 ACFM (137 m³/hr) of the flue gas through a series of pipes into the sample fixture by means of a fan.

In the second configuration, 1.25″×12″ (3.175 cm×30.48 cm) strips of SPC were installed on a frame fixture 2′×2′×1′ (61 cm×61 cm×30 cm) whereas the top and bottom of the strip was fixed in place along rails of the frame capable of holding up to 100 strips. The rails were separated by 2 inches (50 mm) to provide unimpeded flow across the frame. The frame was inserted into a 2.1′×2.1′×8′ (0.66 m×0.66 m×2.4 m) insulated Pilot Tower Unit. The samples were exposed by pulling approximately 2880 ACFM (4860 m³/hr) of the flue gas by means of a fan.

In both cases, the flow rate and pressure differential were monitored across the sample fixture. The composition of the effluent gas was highly variable, however the typical composition of the flue gas comprised a Mercury concentration of 2 μg/m³, an SO₂ concentration of 20-40 ppm, and O₂ concentration of 6%, a NO concentration of 200 ppm, and the relative humidity was >95%. The effluent gas temperature was typically 50-55° C.

Approximately once per month (e.g., every 30 days), a sample was taken and analyzed by XRF for iodine content. The iodine content was tracked over time.

### Samples

### Example 1—SPC Tape with No AgI for Sorption Evaluation

A sorbent polymer composite was created under laboratory conditions comprised of 55 wt % wood-based activated carbon (NUCHAR SA-20, Ingevity, SC, USA) and 45 wt % PTFE (based on the total wt % of the SPC) and was prepared using the general dry blending methodology taught in U.S. Pat. No. 7,791,861 to form composite samples.

### Example 2—SPC Tape with No AgI for Sorption Evaluation

A sorbent polymer composite was created under laboratory conditions comprised of 75 wt % coal-based activated carbon (Norit PAC-20B, Cabot Inc., TX, USA) and 25 wt % PTFE (based on the total wt % of the SPC) and was prepared using the general dry blending methodology taught in U.S. Pat. No. 7,791,861 to form composite samples.

### Example 3—SPC Tape with Wood-Based Carbon

A wood-based activated carbon (NUCHAR SA-20, Ingevity, SC, USA) was impregnated with 1 wt % silver iodide (AgI) using the Example AgI Loading Method 1. A sorbent polymer composite was then created under laboratory conditions comprised of 53 wt % above mentioned AgI loaded activated carbon, 42 wt % PTFE, and 5 wt % sulfur (based on the total wt % of the SPC) and was prepared using the general dry blending methodology taught in U.S. Pat. No. 7,791,861 to form composite samples.

### Example 4—SPC Tape with Coal-Based Carbon 1

A coal-based activated carbon (Norit Vapure612, Cabot Inc., TX, USA) was impregnated with 1 wt % silver iodide (AgI) using the Example AgI Loading Method 1. A sorbent polymer composite was then created under laboratory conditions comprised of 72 wt % above mentioned AgI impregnated activated carbon, 22 wt % PTFE, and 6 wt % sulfur (based on the total wt % of the SPC) and was prepared using the general dry blending methodology taught in U.S. Pat. No. 7,791,861 to form composite samples.

### Example 5—SPC Tape with Coal-Based Carbon 2

A coal-based activated carbon (Norit PAC-20B, Cabot Inc., TX, USA) was impregnated with 1 wt % silver iodide (AgI) using the Example AgI Loading Method 1. A sorbent polymer composite was then created under laboratory conditions comprised of 72 wt % above mentioned AgI impregnated activated carbon, 22 wt % PTFE, and 6 wt % sulfur (based on the total wt % of the SPC) and was prepared using the general dry blending methodology taught in U.S. Pat. No. 7,791,861 to form composite samples.

### Example 6—SPC Tape with Dry Mixed AgI

A coal-based activated carbon (Norit PAC-20B, Cabot Inc., TX, USA) was mixed with 1 wt % silver iodide (AgI) powder using the Example AgI Loading Method 3. A sorbent polymer composite was then created under laboratory conditions comprised of 72 wt % above mentioned AgI mixed activated carbon, 22 wt % PTFE, and 6 wt % sulfur (based on the total wt % of the SPC) and was prepared using the general dry blending methodology taught in U.S. Pat. No. 7,791,861 to form composite samples.

### Example 7—SPC Tape with No AgI (Comparative Example)

A sorbent polymer composite was created under laboratory conditions comprised of 72 wt % coal-based activated carbon (Norit PAC-20B, Cabot Inc., TX, USA), 22 wt % PTFE, and 6 wt % sulfur (based on the total wt % of the SPC) and was prepared using the general dry blending methodology taught in U.S. Pat. No. 7,791,861 to form composite samples.

### Example 8—SPC Tape with Coal-Based Carbon 2

A coal-based activated carbon (Norit PAC-20B, Cabot Inc., TX, USA) was impregnated with 8.22 wt % silver iodide (AgI) using the Example AgI Loading Method 2. A sorbent polymer composite was then created under laboratory conditions comprised of 71 wt % above mentioned AgI impregnated activated carbon, 24 wt % PTFE, and 6 wt % sulfur (based on the total wt % of the SPC) and was prepared using the general dry blending methodology taught in U.S. Pat. No. 7,791,861 to form composite samples.

### Examples of Other Metal Halides

Several other transition metal halides were tested and determined to have effective properties. For example, copper iodide (CuI) was tested and found to have Hg removal efficiency of about 30% to about 70%. For example, mercuric iodide (HgI₂) was tested and found to have Hg removal efficiency of over 16%, under dry conditions (wood based SA20 carbon powder imbibed with 10 wt % HgI₂ with IPA). In another example, silver bromide (AgBr) was also found to be effective in Hg removal. In a 1 wt % AgBr impregnated PAC-20BF carbon tape test, Hg removal efficiency was around 35% (above 25%, and less than 50%). In another example, silver chloride (AgCl) was also found to be effective in Hg removal. In a 1 wt % AgCl impregnated PAC-20BF carbon tape test, Hg removal efficiency was around 30% (above 20%, and less than 40%).

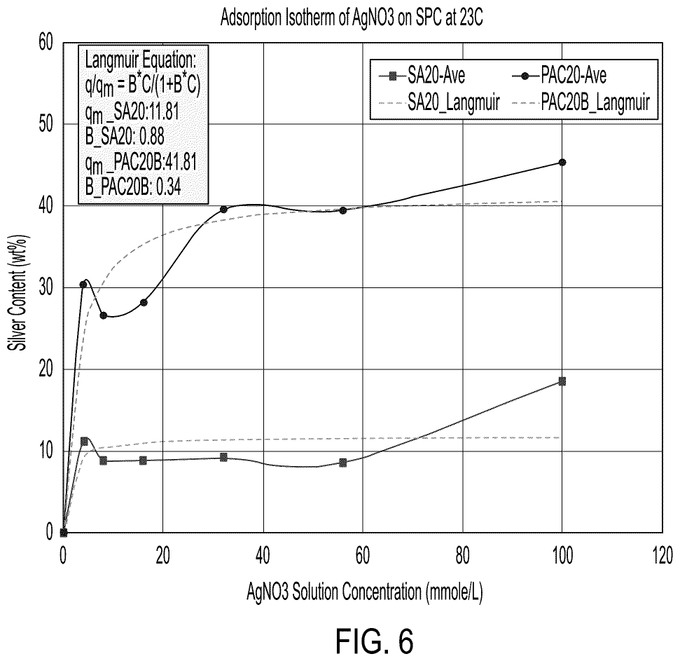

FIG. 6 shows the Langmuir Isotherm determination graphs for Example 1 and Example 2. The SPC samples from Examples 1 and 2 were evaluated using the Sorption Isotherm test and model fitted using the above described method. FIG. 6 shows that the Langmuir parameters of the sample according to Example 1 was: qₘ=11.81 wt %, B=0.88 L/mmole. FIG. 6 shows that the Langmuir parameters of the sample according to Example 2 was: qₘ=41.81 wt %, B=0.34 L/mmole. Further, from the curve fit (dashed line), it can be calculated that the sorbent has an adsorption capacity Langmuir Isotherm parameter qₘ, for a non-halide salt of a transition metal silver nitrate (AgNO₃) of 1,765 mmole/L or more at 23° C.

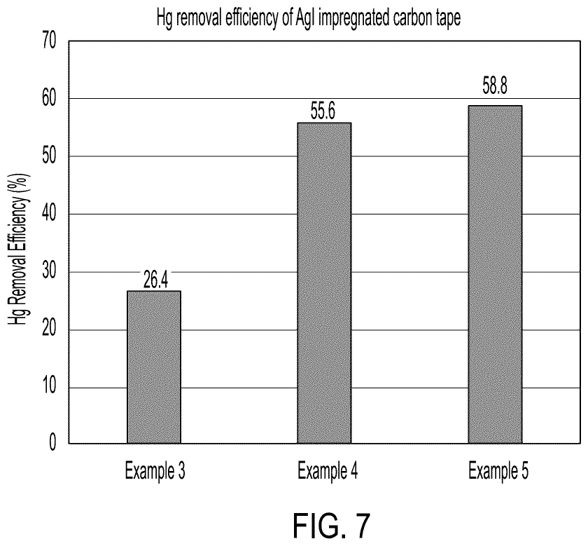

FIG. 7 shows the evaluation data of mercury removal efficiency test for Examples 3, 4, and 5. For Example 3, the mercury removal efficiency was determined to be 26.4%. For Example 4, the mercury removal efficiency was determined to be 55.6%. For Example 5, the mercury removal efficiency was determined to be 58.8%.

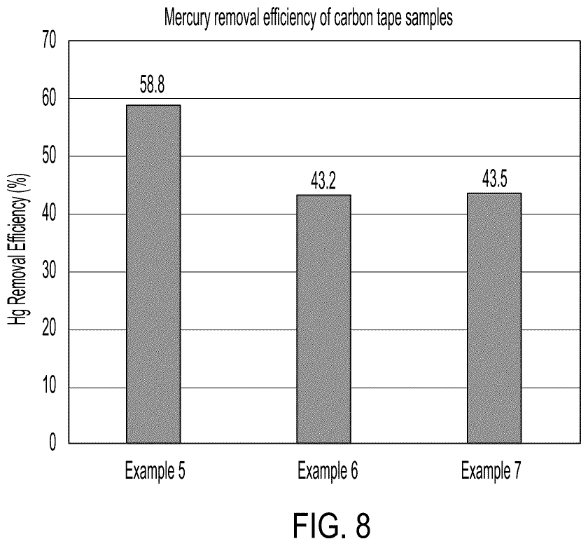

FIG. 8 shows the evaluation data of mercury removal efficiency test for Examples 5, 6, and 7. For Example 5, the mercury removal efficiency was determined to be 58.8%. For Example 6, the mercury removal efficiency was determined to be 43.3%. For Example 7, the mercury removal efficiency was determined to be 43.5%.

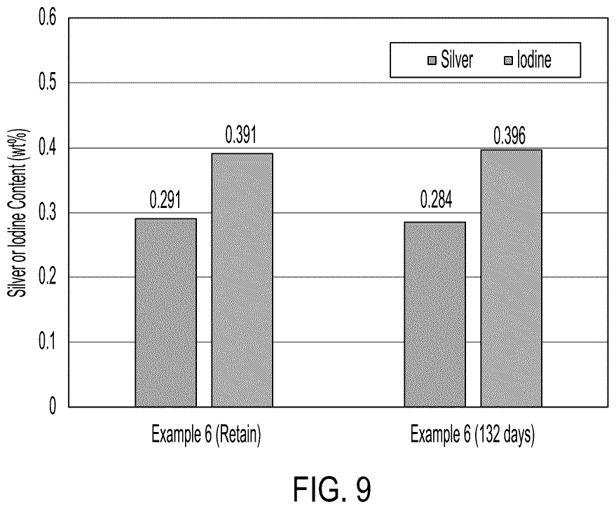

FIG. 9 shows the evaluation data from a lab durability (simulated exposure) test for Example 6. The durability test for Example 6 ran for 132 days. The silver and iodine contents were individually compared to a “retain” sample (e.g., the initial content or a sample which was not “exposed” to the flue gas). It was found that there was no appreciable silver or iodine content loss after 132 days of simulated exposure.

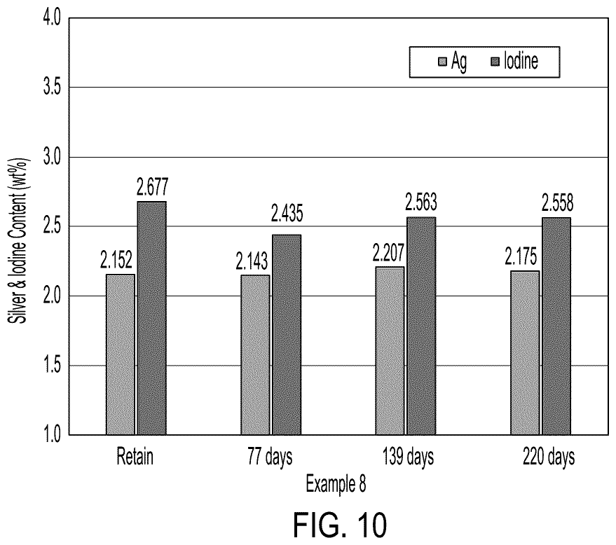

FIG. 10 shows the evaluation data from a lab durability (simulated exposure) test for Example 8. The durability test for Example 8 ran for 77 days, 139 days, and 200 days. The silver and iodine contents were individually compared to a “retain” sample (e.g., the initial content or a sample which was not “exposed” to the flue gas). It was found that there was no appreciable silver or iodine content loss after 77, 139, and 200 days of simulated exposure.

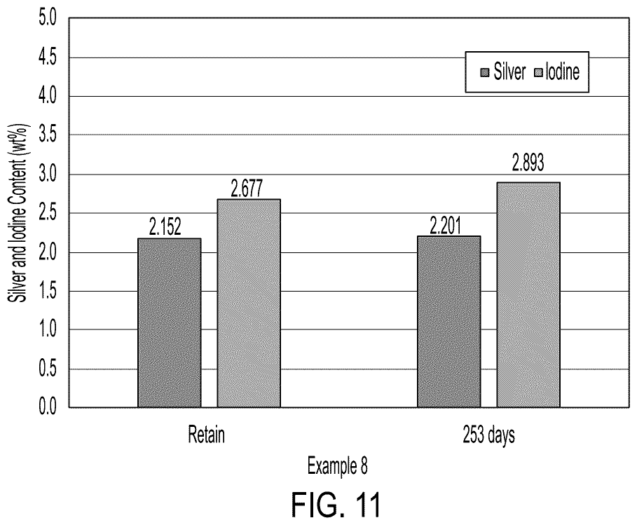

FIG. 11 shows another evaluation data from a field durability test (slipstream of a wet flue gas desulfurization absorber unit on a coal fire powered plant) for Example 8. The durability test for Example 8 ran for 253 days. The silver and iodine contents were individually compared to a “retain” sample (e.g., the initial content or a sample which was not “exposed” to the flue gas). It was found that there was no appreciable silver or iodine content loss after the flue gas exposure compared to that of retain sample.

The advantageous and unexpected results of there being no appreciable silver and iodine content loss can be understood as follows.

Various examples of SPC samples were tested using X-ray Absorption Near Edge Spectroscopy (“XANES”) to determine the particular species of Mercury that is(are) being captured on the activated carbon of the SPC. XANES involves subjecting a sample to high energy X-rays (e.g., generally from a Synchrotron), and measuring and determining the X-ray absorbance as a function of X-ray energy. The position and shape of the near edge absorption can provide information about the oxidation state of an element. The position and shape can also be used as a fingerprint to identify unknowns if suitable standards are provided.

The findings described herein shows that AgI works differently compared to other iodine sources (e.g., KI, TBAI), as in that AgI is(are) not consumed, do not participate in the reaction, or both. Rather, AgI forms a different species of Mercury (e.g., HgS), presumably via a catalytic reaction or some participation in the form thereof.

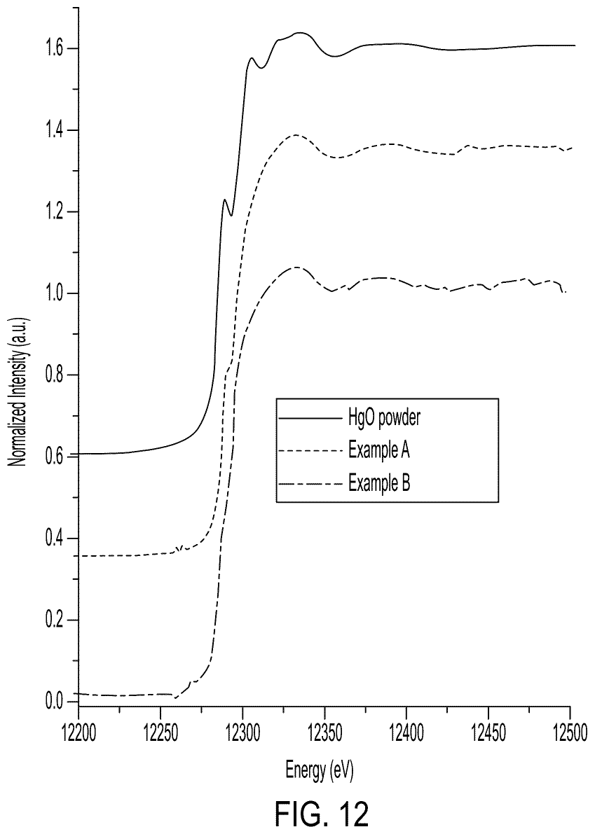

FIG. 12 shows XANES graphs for Example A and Example B, and as a comparison, a graph for HgO powder.

Example A is a nonlimiting SPC sample with no AgI exposed to Hg. To prepare this Example, a sorbent polymer composite was created under laboratory conditions with 76% coal-based activated carbon (Norit PAC-20B, Cabot Inc., TX, USA), and 19% PTFE. The SPC and was prepared using a general dry blending methodology (e.g., see U.S. Pat. No. 7,791,861). An 18 mm diameter disk of SPC of this sample was placed in a closed container containing a few drops of elemental mercury (Hg). The container was placed in an oven at 70° C. for 1 hour to expose the SPC to mercury vapors. A portion of the treated sample was analyzed by XRF and shown to contain approximately 0.6 wt % Hg.

Example B is another nonlimiting SPC sample with AgI exposed to Hg. To prepare this Example, a sorbent polymer composite was created under laboratory conditions with 80 wt % coal-based activated carbon (Norit PAC-20B, Cabot Inc., TX, USA), which was loaded with 5 wt % silver iodine (AgI) according to the Example AgI Loading Method 2 (see above), and 20 wt % PTFE. The SPC the was prepared using the general dry blending methodology (e.g., see U.S. Pat. No. 7,791,861). A 6″×1″ strip of the SPC of this sample was placed in a closed container containing a few drops of elemental mercury (Hg). The container was placed in an oven at 60° C. for 66 hours to expose the SPC to mercury vapors. A portion of the treated sample was analyzed by XRF and shown to contain approximately 0.6 wt % Hg.

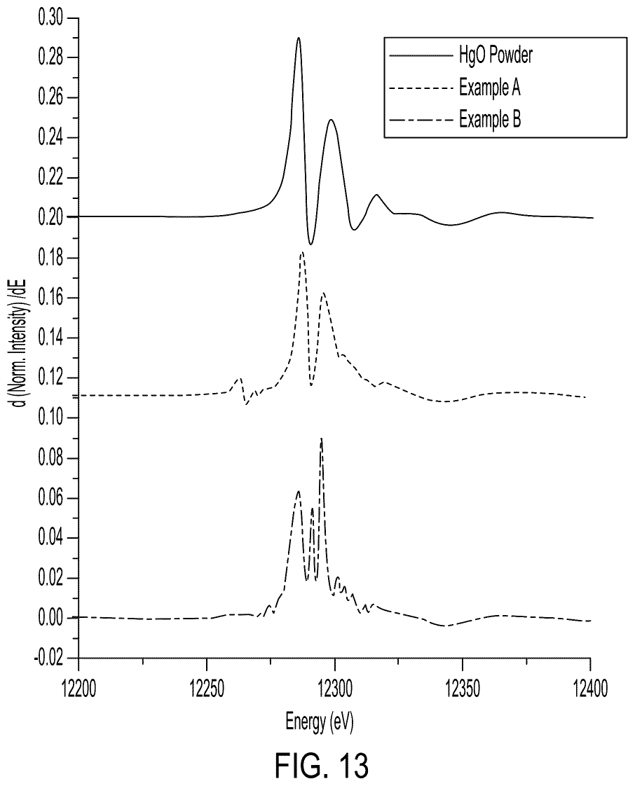

As shown in FIG. 12, Example A and Example B were evaluated to determine what mercury species the Examples contained, by obtaining the XANES spectrum of the Hg L₁₁₁ edge and comparing the obtained spectra to reference spectra for mercury oxide (HgO). The XANES spectrum showed that the mercury on the SPC was primarily present in the form of HgO by comparison. It has been determined that elemental mercury, captured by activated carbon, was found by XANES analysis to be in the form of HgO. The absence of any new features in the XANES spectrum shows that AgI does not react with Hg to any significant extent. FIG. 13 shows a derivatives of the XANES spectra of the Hg L₁₁₁ edge for Example A, Example B, and the reference HgO spectrum. FIG. 13 agrees with and supports the above determination.

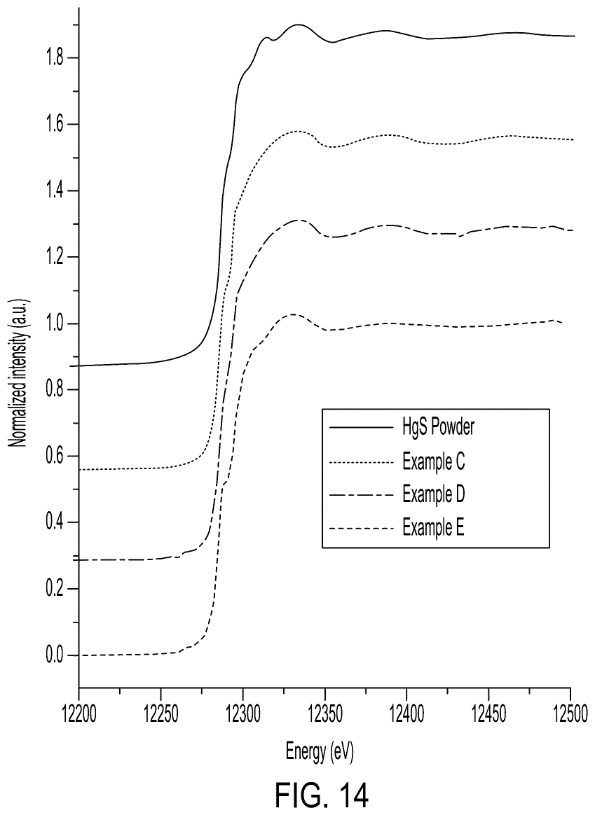

FIG. 14 shows XANES graphs for Example C, Example D, and Example E, and as a comparison, a graph for HgS powder.

Example C is another nonlimiting SPC sample with no AgI and Sulfur exposed to Hg. To prepare this Example, a sorbent polymer composite was created under laboratory conditions with 76 wt % coal-based activated carbon (Norit PAC-20B, Cabot Inc., TX, USA), 19 wt % PTFE, and 5 wt % sulfur (S). The SPC was prepared using the general dry blending methodology (e.g., see U.S. Pat. No. 7,791,861) to form composite samples. A total of seven 18 mm diameter disks of SPC of this sample was placed in a closed container containing a few drops of elemental mercury (Hg). The container was placed in an oven at 70° C. for 19 hours to expose the SPC to mercury vapors. A portion of the treated sample was analyzed by XRF and shown to contain approximately 2.4 wt % Hg.

Example D is yet another nonlimiting SPC sample with AgI and Sulfur exposed to Hg. To prepare this Example, a sorbent polymer composite was created under laboratory conditions with 76 wt % coal-based activated carbon (Norit PAC-20B, Cabot Inc., TX, USA), which was loaded with 5 wt % AgI according to the Example AgI Loading Method 2, 19 wt % PTFE, and 5 wt % sulfur (S). The SPC was prepared using the general dry blending methodology (e.g., see U.S. Pat. No. 7,791,861). A total of seven 18 mm diameter disks of SPC of this sample was placed in a closed container containing a few drops of elemental mercury (Hg). The container was placed in an oven at 70° C. for 19 hours to expose the SPC to mercury vapors. A portion of the treated sample was analyzed by XRF and shown to contain approximately 4.1 wt % Hg.

Example E is another nonlimiting SPC sample that contains Sulfur and AgI (with low silver content) which has been exposed to Hg. To prepare this Example, a sorbent polymer composite was created under laboratory conditions with of 76 wt % coal-based activated carbon (Norit PAC-20B, Cabot Inc., TX, USA), which was loaded with 1 wt % AgI according to the Example AgI Loading Method 2, 19 wt % PTFE, and 5 wt % sulfur (S). The SPC was prepared using the general dry blending methodology (e.g., see U.S. Pat. No. 7,791,861). A total of seven 18 mm diameter disks of SPC of this sample was placed in a closed container containing a few drops of elemental mercury (Hg). The container was placed in an oven at 70° C. for 165 hours. A portion of the treated sample was analyzed by XRF and shown to contain approximately 4.6 wt % Hg.

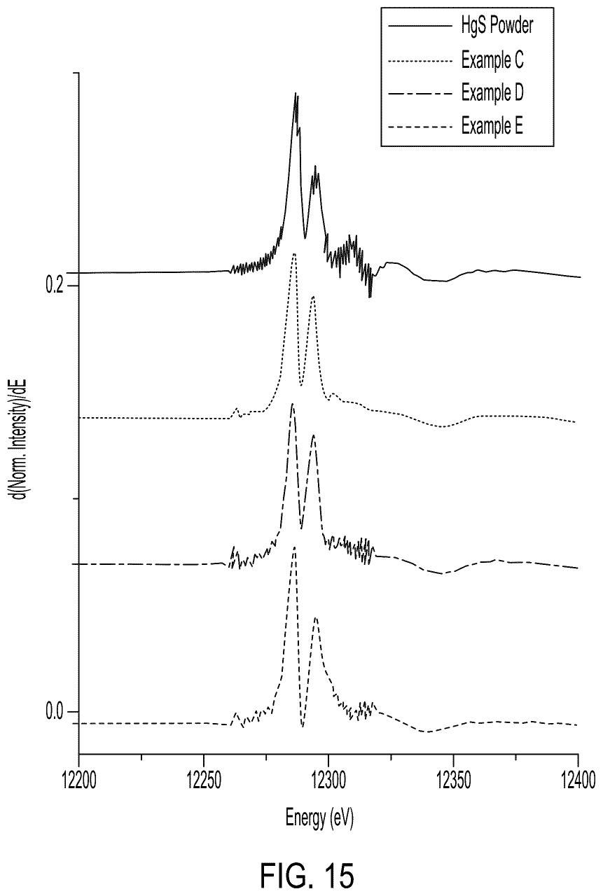

As shown in FIG. 14, the Examples C, D, and E were evaluated for determining what mercury species were contained therein via XANES of the Hg Lil edge. The spectra were compared to a reference spectra for mercury sulfide (HgS). The XANES spectra of the Examples C, D, and E indicated that the mercury on the SPCs were primarily present in the form of HgS. The absence of any new features in the XANES spectrum shows that AgI does not react with Hg to any significant extent. There was no evidence of any new mercury species that might be associated with AgI. FIG. 15 shows a derivatives of the XANES spectra of the Hg L₁₁₁ edge for Examples C, D, E, and the reference HgS spectrum. FIG. 15 agrees with and supports the above determination.

Surprisingly, while there was no evidence for reaction of Hg with AgI, the amount of mercury absorbed increased dramatically from Example C (2.4%) to Example D (4.1%) and example E (4.6%) suggesting a strong promoting effect of AgI.

In some embodiments, the SPC utilizes an inert, non-carbonaceous support as the sorbent. That is, according to some embodiments, the sorbent does not include carbon. In some embodiments, the sorbent includes both carbon and non-carbonaceous support.

A nonlimiting example of a non-carbonaceous support can be produced as follows. Obtain a 10 mL of liquid toluene, which is held at a temperature of 50° C., and add an excess of elemental sulfur by decantation to 10 g of MS-3030 mesoporous silica (PQ corporation, Valley Forge, PA, USA) under continuous stirring. Toluene is then evaporated at 120° C. and the sample is dried (e.g., overnight). In a subsequent step, 10 mL of an aqueous solution containing 0.2 g silver nitrate (AgNO₃) is added to the sulfur enriched silica support under continuous stirring. Excess water is then evaporated at 120° C., and the sample dried (e.g., overnight). The AgNO₃ and Sulfur enriched sample is then placed into a sealed vessel containing an excess of elemental iodine in a separate open vial. The sealed vessel is then placed in an oven at 60° C. (e.g., overnight). The vessel is then purged, and the iodine vial removed. A final drying step at 120° C. is then performed for driving off any remaining elemental iodine, producing the non-carbonaceous support which can be or be a part of the sorbent, according to some embodiments.

The samples made according to the above have been evaluated by EDX. The test results indicate a stoichiometric ratio of iodine (I) to silver (Ag), indicative of direct conversion of AgNO₃ to AgI. Because of the above procedure, it is expected that the AgI is evenly distributed and co-located with elemental sulfur (S), and the highly reactive AgI forms a shell around the final Hg acceptor, which is the sulfur.

The examples described herein are nonlimiting representatives of the various embodiments and their combinations that have been tested to have or are expected to have similar results, similar properties, similar advantages, or a combination thereof.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1.-44. (canceled)

45. A sorbent polymer composite (SPC), comprising:
a polymer; and
a sorbent,
wherein the sorbent includes a microstructure
wherein the microstructure comprises a transition metal halide.

46. The SPC of claim 45, further comprising sulfur.

47. The SPC of claim 46, wherein the sulfur is present in an amount ranging from 0.1 wt % to 20 wt % based on a total weight of the SPC.

48. The SPC of claim 46, wherein the sulfur is present in an amount ranging from 3 wt % to 5 wt % based on a total weight of the SPC.

49. The SPC of claim 45, wherein the transition metal halide is a transition metal iodide and comprises at least one of: nickel, lead, copper, manganese, iron, mercury, silver, platinum, or any combination thereof.

50. The SPC according to claim 45, wherein the transition metal halide comprises silver iodide (AgI).

51. The SPC according to claim 50, wherein the SPC is configured for at least 6 months of operational use for reacting with mercury (Hg), wherein a concentration of silver (Ag) is substantially unchanged or is not reduced throughout the at least 6 months of operational use.

52. The SPC of claim 45, wherein the sorbent has an adsorption capacity Langmuir Isotherm parameter qm, for a non-halide salt of a transition metal silver nitrate (AgNO3) of 1,765 mmole/L or more at 23° C.

53. The SPC of claim 45, wherein the polymer comprises a fluoropolymer.

54. The SPC according to claim 45, wherein the transition metal halide is present in the SPC an amount of 0.1 wt %. to 20 wt % based on a total weight of the SPC.

55. The SPC of claim 45, wherein the sorbent comprises activated carbon, a silica gel, a zeolite, or any combination thereof.

56. A method, comprising:
obtaining a sorbent polymer composite (SPC), wherein the SPC comprises a polymer and a sorbent;
obtaining a non-halide salt of a transition metal;
obtaining a non-transition metal halide;
applying the non-halide salt of the transition metal to the sorbent, so as to incorporate the non-halide salt of the transition metal within a microstructure of the sorbent; and
applying the non-transition metal halide to the sorbent, so as to react the non-transition metal halide with the non-halide salt of the transition metal, thereby forming a transition metal halide within the microstructure of the sorbent.

57. The method of claim 56, wherein a non-transition metal salt is also formed within the microstructure of the sorbent,
wherein the method further comprises:
removing the non-transition metal salt from the sorbent comprising dissolving the non-transition metal salt from the sorbent using a solvent.

58. The method of claim 56,
wherein the sorbent comprises activated carbon;
wherein the non-halide salt of the transition metal comprises silver nitrate (AgNO3);
wherein the non-transition metal halide is potassium iodide (KI); and
wherein the transition metal halide is silver iodide (AgI); and
wherein reaction of the non-halide salt of the transition metal with the non-transition metal halide comprises the following: Ag [symbol] NO [symbol] 3+KI→AgI+K [symbol] N [symbol] 3.

59. A method, comprising:
obtaining a sorbent polymer composite (SPC), wherein the SPC comprises:
a transition metal halide, and
sulfur; and
flowing a gas comprising mercury to contact the SPC, whereby mercury sulfide (HgS) is formed by a catalytic reaction of the mercury and the sulfur wherein the transition metal halide acts as a catalyst.

60. The method of claim 59, wherein the transition metal halide comprises silver (Ag), and wherein the flowing the gas is operated for at least 6 months, wherein a concentration of silver (Ag) of the SPC is substantially unchanged throughout the at least 6 months.

61. The method of claim 59, wherein the flowing the gas is operated for at least 6 months,
wherein the transition metal halide comprises iodine or iodide (I),
wherein a concentration of iodine or iodide (I) of the SPC is substantially unchanged throughout the at least 6 months.
